(19) United States
(12) Patent Application Publication
(10) Pub. No.: US 2026/0057597 A1
(43) Pub. Date: Feb. 26, 2026

(54) GENERATION OF TEXTURE DATA BASED ON PAIRS OF MULTI-VIEW DIGITAL IMAGES

(71) Applicant: Adobe Inc., San Jose, CA (US)

(72) Inventors: Romain Rouffet, Lyon (FR); Vladimir Kim, Seattle, WA (US); Valentin Deschaintre, London (GB); Thibault Groueix, San Francisco, CA (US); Rosalie Martin, Lyon (FR); Duygu Ceylan Aksit, London (GB); Chun-Hao Huang, London (GB)

(21) Appl. No.: 18/815,721

(22) Filed: Aug. 26, 2024

(51) Int. Cl. G06T 15/04; G06T 5/70; G06T 17/20

(52) U.S. Cl. CPC G06T 15/04; G06T 5/70; G06T 17/205; G06T 2207/20084; G06T 2210/36

(57) ABSTRACT

A texture data generation computing system generates texture data for 3D digital objects based on pairs of multi-view digital images. A rendering engine generates a multi-view rendered image including a set of rendered views depicting a 3D digital object. A diffusion image generation model generates a multi-view diffusion-generated image including a set of diffusion-generated views depicting the 3D digital object with a visual appearance. In addition, the diffusion image generation model determines, for each diffusion-generated view, a respective cross-frame attention feature set describing additional diffusion-generated views. Based on a texture depicted in the set of diffusion-generated views, the texture data generation computing system modifies a texture data object. In some cases, the texture data generation computing system provides the modified texture data object to an additional computing system configured to modify a digital graphical environment based on the texture data object.

### TECHNICAL FIELD

This disclosure relates generally to the field of texturing three-dimensional digital objects, and more specifically relates to generating texture maps via neural network models.

### BACKGROUND

A three-dimensional (“3D”) digital object includes texture data, which provides an appearance for the 3D digital object. The texture data, such as a texture map, can be applied to the 3D digital object during generation, e.g., rendering, of the 3D digital object. In some cases, the 3D digital object with the texture data is included in a digital graphical environment, such as a computer-implemented game, a virtual reality (“VR”) environment, or other types of digital graphical environments.

In some cases, it is desirable for a 3D digital object to have high-quality texture data that provides a particular appearance, such as a realistic appearance or an appearance with a particular artistic style. Contemporary techniques for generating high-quality texture data often rely on extensive manual effort to modify a texture map or other texture data, such as manual “painting” techniques for modifying individual areas of a texture map. However, using manual effort to generate high-quality texture data can be inefficient, requiring a large expenditure of time by one or more highly trained specialists, such as a graphical design specialist.

### SUMMARY

According to certain embodiments, a texture data generation computing system generates texture data for 3D digital objects. A rendering engine included in the texture data generation computing system generates at least one multi-view rendered digital image including a set of rendered views depicting a 3D digital object. Based on the multi-view rendered digital image, a diffusion image generation model included in the texture data generation computing system generates at least one multi-view diffusion-generated digital image including a set of diffusion-generated views depicting the 3D digital object with a requested visual appearance. In addition, the diffusion image generation model determines, for each diffusion-generated view, a respective cross-frame attention feature set that describes relationships among additional diffusion-generated views in the set. Based on the at least one multi-view diffusion-generated digital image, the texture data generation computing system generates or modifies a texture data object, such as by calculating texture data values based on a texture depicted in the set of diffusion-generated views of the 3D digital object. In some cases, the texture data generation computing system provides the modified texture data object, or a textured 3D digital object based on the modified texture data object, to an additional computing system that is configured to modify a digital graphical environment based on the modified texture data object or the textured 3D digital object. In some cases, the texture data generation computing system performs multiple passes of texture-generation techniques based on pairs of multi-view digital images, such as multiple pairs of multi-view rendered digital images with corresponding multi-view diffusion-generated digital images.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram depicting an example of a computing environment in which texture data for 3D digital objects is generated, according to certain embodiments;

FIG. 2 is a diagram depicting an example of a texture data generation computing system that is configured to generate texture data for 3D digital objects, according to certain embodiments;

FIG. 3 is a diagram depicting examples of data structures related to generating texture data for 3D digital objects, according to certain embodiments;

FIG. 4 is a flow chart depicting an example of a process for generating texture data for 3D digital objects, according to certain embodiments;

FIG. 5 is a flow chart depicting an example of a process for generating refined texture data or infilled texture data for 3D digital objects, according to certain embodiments;

FIG. 6 is a flow chart depicting an example of a process for generating texture data for 3D digital objects based on one or more cross-frame attention features, according to certain embodiments; and

FIG. 7 is a block diagram depicting an example of computing system that can be configured to implement a texture data generation computing system, according to certain embodiments.

### DETAILED DESCRIPTION

As discussed above, prior techniques for generating texture data for three-dimensional (“3D”) digital objects are inefficient, relying on extensive manual effort. In some cases, such manual effort is often provided by human specialists, such as highly skilled specialists who are trained in graphical design, 3D texture mapping, or other skill sets that are related to generating texture data. In addition, utilizing manual effort is costly, and may require a relatively large expenditure of financial resources (e.g., payment for the highly skilled specialists) and computing resources (e.g., individual computing workstations for the highly skilled specialists). Additionally or alternatively, contemporary approaches for generating texture data have attempted to generate two-dimensional (“2D”) images that could be applied to various regions, e.g., “stitched” regions, on a 3D digital object. However, contemporary approaches using stitched 2D images may fail to eliminate visual boundaries between regions. For example, a 3D digital object generated using the contemporary texture map with visual boundaries may have a poor appearance in digital graphical environments, such as a poor appearance that includes visible lines in inappropriate locations on the 3D digital object or inconsistent colors at the edges of the stitched 2D images.

Certain embodiments described herein provide for a texture data generation computing system that generates texture data for 3D digital objects based on one or more pairs of multi-view digital images, such as an image pair including a multi-view rendered digital image and a corresponding multi-view diffusion-generated digital image. In this example, the multi-view rendered digital image depicts multiple rendered views of an untextured 3D digital object, e.g., the 3D digital object lacks texture data. A trained neural network included in the texture data generation computing system, such as a diffusion image generation model, is configured to generate the multi-view diffusion-generated digital image based on the multi-view rendered digital image, or a combination of the multi-view rendered digital image with additional data. In some cases, the trained neural network generates the multi-view diffusion-generated digital image based on the multi-view rendered digital image combined with appearance input data that describes a requested visual appearance for the 3D digital object. In addition, the trained neural network determines one or more sets of cross-frame attention features for the multi-view diffusion-generated digital image, such as a particular cross-frame attention feature set for each diffusion-generated view corresponding to a particular rendered view. In some cases, determining the sets of cross-frame attention features improves consistency among the multiple diffusion-generated views, such as by improving consistent calculation of data values (e.g., color data values, brightness data values) that depict the appearance of the 3D digital object in the diffusion-generated views. Based on the multi-view diffusion-generated digital image, the texture data generation computing system generates or modifies a texture data object to include texture data indicating the appearance of the diffusion-generated views, such as a texture map that indicates color or other texture values calculated from the diffusion-generated views. In some cases, generating or modifying a texture data object based on the multi-view diffusion-generated digital image improves consistency of the generated texture data, such as by improving consistent calculation of texture data values included in the texture data object. For example, the texture data object can include texture elements (“texels”) having texture data values (e.g., texel color values). In addition, the texture data generation computing system modifies, or causes a modification to, one or more digital graphical environments based on the texture data object. For example, the texture data generation computing system provides the texture data object to one or more additional computing systems that are configured to generate, for presentation in a digital graphical environment, at least one textured 3D digital object having the texture described by the texture data object. Additionally or alternatively, the texture data generation computing system generates at least one textured 3D digital object having the texture described by the texture data object and provides the textured 3D digital object to one or more additional computing systems that are configured to modify a digital graphical environment to include the textured 3D digital object. In some cases, the example texture data generation computing system provides the texture data object with improved appearance, e.g., as compared to contemporary approaches using stitched 2D images, while reducing expenditure of resources, e.g., computing or financial resources related to manual efforts to generate texture data.

The following examples are provided to introduce certain embodiments of the present disclosure. A texture data generation computing system receives 3D mesh data describing a 3D digital object, and appearance input data describing a requested visual appearance of the 3D digital object, such as text data indicating a requested color, shininess, or other appearance characteristics. Based on the 3D mesh data, a rendering engine included in the texture data generation computing system generates a 2D multi-view rendered digital image that includes a set of multiple rendered views of the 3D digital object. Each of the rendered view in the set depicts the 3D digital object from a particular viewpoint, such that each rendered view depicts the 3D digital object from a different viewing angle and from a similar viewing distance. In a first pass of texture-generation techniques by the texture data generation computing system, the multi-view rendered digital image depicts the 3D digital object as untextured, e.g., without texture data.

Continuing with this example, a trained diffusion image generation model included in the texture data generation computing system generates a 2D multi-view diffusion-generated digital image that includes an additional set of multiple diffusion-generated views of the 3D digital object having the requested visual appearance. For example, the trained diffusion image generation model generates the multi-view diffusion-generated digital image based on a combination of the appearance input data with the multi-view rendered digital image. In some cases, the trained diffusion image generation model applies one or more diffusion image generation techniques to generate the multi-view diffusion-generated digital image, such as diffusion techniques to denoise a noisy image. Examples of diffusion techniques can include stable diffusion, blended diffusion, or other diffusion techniques to generate images. Based on the multiple rendered views, the trained diffusion image generation model modifies corresponding noisy regions of a noisy image, such as modifications via one or more denoising techniques. In addition, each of the modified noisy regions corresponding to a particular rendered view is modified (e.g., iterative denoising modifications) to depict a particular corresponding diffusion-generated view. For example, each rendered view in the set of multiple rendered views corresponds to a particular noisy region and a particular diffusion-generated view in the set of multiple diffusion-generated views. In some cases, the trained diffusion image generation model determines multiple cross-frame attention feature sets that describe relationships among features (e.g., image features) of the multiple diffusion-generated views or corresponding noisy regions, such that each cross-frame attention feature set corresponds to a particular diffusion-generated view and corresponding noisy region. In addition, the trained diffusion image generation model generates each of the cross-frame attention feature sets based on features of additional diffusion-generated views from the set, such that for a particular diffusion-generated view, the trained diffusion image generation model generates the corresponding cross-frame attention feature set based on image features of one or more additional diffusion-generated views or additional noisy regions that exclude the particular diffusion-generated view and particular corresponding noisy region.

Based on the multi-view diffusion-generated digital image, the example texture data generation computing system generates or modifies a texture data object, such as a texture map. For example, the texture data generation computing system calculates one or more texture data values that describe the visual appearance depicted in one or more of the multiple diffusion-generated views in the multi-view diffusion-generated digital image. The texture data values are calculated based on the visual appearance of each of the multiple diffusion-generated views. In addition, the calculated texture data values can describe texture for various regions of the 3D digital object, such as the regions depicted in the multiple rendered views from various viewpoints of the untextured 3D digital object. In some cases, the texture data generation computing system modifies one or more texels in the texture data object based on the calculated texture data values.

Continuing with this example, the texture data generation computing system modifies, or causes a modification to, one or more digital graphical environments based on the generated or modified texture data object. For example, the texture data generation computing system provides the texture data object to one or more additional computing systems. Responsive to receiving the texture data object, the one or more additional computing systems are configured to generate at least one textured 3D digital object having the texture described by the texture data object, such as for presentation in a digital graphical environment. Additionally or alternatively, the texture data generation computing system generates at least one textured 3D digital object having the texture described by the texture data object and provides the textured 3D digital object to one or more additional computing systems. Responsive to receiving the textured 3D digital object, the one or more additional computing systems are configured to modify a digital graphical environment to include the textured 3D digital object.

Certain embodiments described herein provide improvements to techniques for generating texture data for 3D digital object and improvements for computing systems for generating texture data. For example, a texture data generation computing system described herein applies particular rules to determine features of multiple image regions in a digital image, such as noisy regions in a noisy image or regions depicting respective views in a multi-view digital image (e.g., rendered or diffusion-generated). Additionally or alternatively, a texture data generation computing system described herein generates, for each particular image region in a digital image, a respective set of cross-frame attention features by applying additional particular rules to determine a set or subset of additional image regions from which the respective set of cross-frame attention features is determined. By applying the particular rules or the additional particular rules, a texture data generation computing system described herein generates or modifies multiple data structures related to a computer-implemented field of generating textured 3D digital objects, such as texture maps, texels, data values describing 3D digital objects, or other data structures or data values related to generating textured 3D digital objects. In some cases, the application of these rules by the texture data generation computing system achieves an improved technological result, such as improving consistency of appearance (or image data depicting appearance) among multiple image regions in a digital image, such as improved consistency among multiple diffusion-generated views in a multi-view diffusion-generated digital image. Additionally or alternatively, the application of these rules by the texture data generation computing system achieves an improved technological result by reducing expenditure of resources for generating texture data, such as reducing expenditure of time, financial, and computing resources related to manual efforts to generate texture data. Furthermore, the application of these rules by the texture data generation computing system achieves an improved outcome in a technical field, such as an improvement in visual appearance in a technical field of generating textured 3D digital objects.

In some cases, the described techniques for generating texture data improve efficiency of a computing system that implements one or more of the techniques, such as reducing usage of computing resources as compared to contemporary techniques for sequentially determining texture data for multiple portions of a 3D digital object. For example, a texture data generation computing system described herein determines texture data for multiple portions of a 3D digital object by utilizing memory and processing resources to analyze a particular pair of a multi-view rendered digital image and a multi-view diffusion-generated digital image. The memory and processing resources used by the described texture data generation computing system are reduced as compared to a contemporary computing system configured for sequential analysis of multiple images of the portions of the 3D digital object, which expends additional memory and processing resources to analyze at least one additional image for every additional portion (e.g., view) of the 3D digital object.

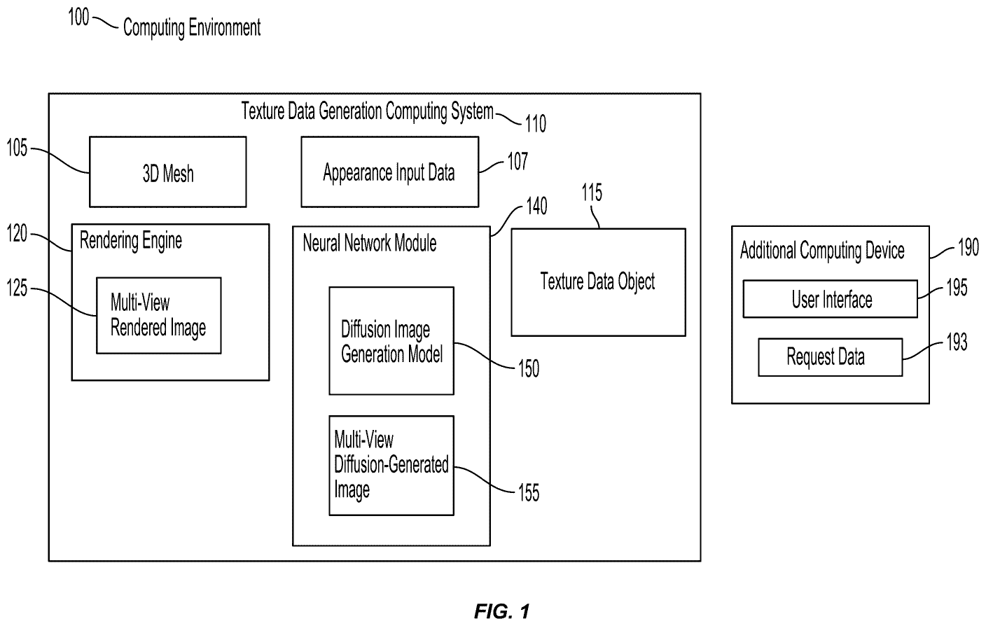

Referring now to the drawings, FIG. 1 is a diagram depicting an example of a computing environment in which texture data for 3D digital objects is generated, such as a computing environment 100. The computing environment 100 includes a texture data generation computing system 110. In addition, the texture data generation computing system 110 includes a rendering engine 120 and a neural network module 140. In some cases, the computing environment 100 includes one or more additional computing systems, such as an additional computing device 190 that includes a user interface 195. In addition, one or more of the texture data generation computing system 110, the additional computing device 190, and additional computing systems included in the computing environment 100 are configured to exchange data via one or more computing networks, such as a local or global area network. FIG. 1 depicts the texture data generation computing system 110 as including the rendering engine 120 and the neural network module 140, but other implementations are possible. For example, a texture data generation computing system could be configured to communicate with one or more of an external rendering engine or an external neural network, e.g., external components that are implemented by one or more additional computing systems.

In some cases, the additional computing device 190 is configured to implement one or more digital graphical environments that are capable of presenting, e.g., to a user of the additional computing device 190, one or more 3D digital objects. For example, the additional computing device 190 configures at least one display device, such as a display device included in the user interface 195, to display image data describing a digital graphical environment (or a local instance thereof), such as a development environment for 3D digital objects, an interactive game environment, a VR collaboration environment, or other types of digital graphical environments. In addition, the additional computing device 190 is configured to implement the one or more digital graphical environments based on information received from (or provided to) the texture data generation computing system 110. For example, the texture data generation computing system 110 could receive, from the additional computing device 190, request data 193 that describes a requested 3D digital object having a requested appearance, such as request data provided via an input device included in the user interface 195. Based on the request data 193, the texture data generation computing system 110 generates one or more texture data objects, such as a texture data object 115, that include texture data describing the requested appearance. In addition, the texture data generation computing system 110 provides, to the additional computing device 190, one or more of the texture data object 115 or a 3D digital object having the texture described by the texture data object 115. Responsive to receiving the texture data object 115 or the 3D digital object, the additional computing device 190 can modify the digital graphical environment (or local instance thereof) to include the 3D digital object having the texture described by the texture data object 115.

In the computing environment 100, the texture data generation computing system 110 generates the texture data object 115 based on one or more pairs of multi-view images, such as a multi-view image pair that includes a multi-view image with rendered image data and an additional multi-view image with diffusion-generated image data, e.g., image data generated via one or more trained neural network models. In some cases, the texture data generation computing system 110 generates one or more of the multi-view images based on a visual appearance described by the request data 193. In addition, the texture data generation computing system 110 generates the multi-view image pair based on cross-frame attention features, e.g., cross-frame attention features identified via one or more trained neural network models. Based on the one or more multi-view image pairs and the cross-frame attention features, the texture data generation computing system 110 generates (or modifies) the texture data object 115 to include one or more texture data values, such as texture data values that describe the requested appearance from the request data 193.

In FIG. 1, the texture data generation computing system 110 receives one or more of a 3D mesh 105 or appearance input data 107. In some cases, the 3D mesh 105 includes data describing a 3D digital object, such as data describing multiple triangles (or other polygon types suitable for 3D mesh data) that are included in a surface of the 3D digital object. In addition, the appearance input data 107 includes data, such as text data, describing a requested appearance for the 3D digital object described by the 3D mesh 105. In some cases, the texture data generation computing system 110 generates or otherwise identifies one or more of the 3D mesh 105 or the appearance input data 107 based on the request data 193. For instance, the request data 193 could indicate one or more of a particular 3D digital object or a requested appearance for the particular 3D digital object. As an example, the texture data generation computing system 110 determines that the request data 193 indicates a particular 3D digital object resembling an apple. Based on the request data 193, the texture data generation computing system 110 identifies the 3D mesh 105, such as by determining that the 3D mesh 105 is a triangle mesh for a 3D digital object resembling an apple. Continuing with this example, texture data generation computing system 110 also determines that the request data 193 further indicates, for the apple object, a requested appearance of “red with a green spot” and “shiny.” Based on the request data 193, the texture data generation computing system 110 generates (or otherwise determines) the appearance input data 107. For example, the texture data generation computing system 110 can generate the appearance input data 107 to include text data describing “red,” “green spot,” and “shiny.” In FIG. 1, the appearance input data 107 includes text data that provides a verbal description of the requested appearance, but other implementations are possible. For example, a texture data generation computing system could generate (or otherwise determine) appearance input data that includes text data, a 2D image provided with request data (e.g., an image provided by a user of the additional computing device 190), a 2D image selected from a texture data repository, or other types of data that describe visual appearance. In some cases, the appearance input data 107 excludes texture data structures configured to be included on a surface of the 3D digital object, e.g., texels that can be applied during rendering of the 3D mesh 105.

In the computing environment 100, the texture data generation computing system 110 generates, via the rendering engine 120, a first multi-view digital image based on the 3D mesh 105. For example, the rendering engine 120 generates multiple views of the 3D digital object described by the 3D mesh 105. In addition, the rendering engine 120 renders (e.g., generates) 2D images based on the views, such as a respective 2D rendered image for each particular view of the multiple views. In some cases, the multiple views are selected at different viewpoints, such that each particular view depicts a different portion of the 3D digital object (e.g., top portions, bottom portions, side portions). Additionally or alternatively, the multiple views are selected at viewpoints having different viewing angles of the 3D digital object and same (or similar) distances from the 3D digital object, such that each particular view depicts a different portion of the 3D digital object from a same (or similar) viewpoint distance.

In FIG. 1, the rendering engine 120 (or another component of the texture data generation computing system 110) generates a multi-view rendered image 125 that is based on a combination of the 2D rendered images. In some cases, the multi-view rendered image 125 is a 2D composite image that includes the 2D rendered images (or a subset thereof) for the multiple views. In addition, the multi-view rendered image 125 includes the 2D rendered images arranged as a grid, such that each image region of the multi-view rendered image 125 depicts a particular view from the multiple views. In addition, the multi-view rendered image 125 includes particular portions of the 2D rendered images, such as a cropped portion that includes the respective view of each 2D rendered image and omits additional (e.g., background) portions of each 2D rendered image. Continuing with the above example of a 3D digital object resembling an apple, the rendering engine 120 renders twenty-five views of the 3D mesh 105 (e.g., different viewpoint angles at a same or similar viewpoint distance). Based on the example twenty-five rendered views, the multi-view rendered image 125 includes a 5×5 array of the twenty-five views, each particular region of the array depicting a respective view of the apple object. Additional examples of a multi-view rendered image generated by a texture data generation computing system can include grids (or other organizational formats) of an n×m array of views (e.g., sixteen views in a 4×4 array), an n×m array of views (e.g., twenty-four views in a 4×6 array), irregular arrays (e.g., rows or columns having various lengths), or other types of presentations for multiple views of a 3D digital object.

Based on the multi-view rendered image 125, the texture data generation computing system 110 generates, via the neural network module 140, a second multi-view digital image. For example, the neural network module 140 includes one or more models trained to generate 2D digital images, such as a trained diffusion image generation model 150 (also referred to herein as the “diffusion model 150”). The trained diffusion model 150 generates a multi-view diffusion-generated image 155, based on one or more of the multi-view rendered image 125 or the appearance input data 107. For example, the trained diffusion model 150 determines, based on the appearance input data 107, one or more visual appearance characteristics that are requested, such as the example appearance described by “red,” “green spot,” and “shiny.” In addition, the trained diffusion model 150 modifies a noisy image, such as via a denoising image generation technique, based on a combination of data included in the multi-view rendered image 125 and the appearance input data 107. For example, the trained diffusion model 150 generates the multi-view diffusion-generated image 155 by modifying the noisy image (e.g., via iterative denoising operations) to include images of the multiple views depicted in the multi-view rendered image 125 having the visual appearance indicated by the appearance input data 107. In FIG. 1, the trained diffusion model 150 is a particular trained diffusion model, but other implementations are possible, such as a combination of multiple diffusion image generation models (or multiple types of diffusion image generation models).

In some cases, the multi-view diffusion-generated image 155 is a 2D image that includes the 2D diffusion-generated views that correspond to the multiple views depicted in the multi-view rendered image 125. Continuing with the above example of the requested apple and appearance, the multi-view diffusion-generated image 155 includes multiple diffusion-generated views of the apple object having the requested appearance of “red with a green spot” and “shiny.” Corresponding to the example twenty-five rendered views included in the multi-view rendered image 125, the multi-view diffusion-generated image 155 includes an additional 5×5 array of twenty-five diffusion-generated views, each particular region of the additional array depicting a respective diffusion-generated view of the apple object having an appearance of shiny and red with a green spot. In this example, various views in the additional array can depict various portions of the apple object's appearance, such as a first view from a first viewing angle in which the green spot is visible and a second view from a second viewing angle in which the green spot is occluded (e.g., not visible).

In FIG. 1, the trained diffusion model 150 generates the multi-view diffusion-generated image 155 based on cross-frame attention features, such as image features identified from one or more of the multi-view rendered image 125 or the noisy image from which the multi-view diffusion-generated image 155 is generated (e.g., features identified during iterative denoising operations). Examples of image features can include vector representations (or other digital representations, including digital representations not intended for human interpretation) that describe relationships among pixels (or other elements) in a digital image, such as mathematical relationships among pixels in the multi-view rendered image 125 or the noisy image. In some cases, the trained diffusion model 150 determines (or otherwise receives) a set of cross-frame attention features that describe image features among the multiple views, or a subset of the multiple views, from the images 125 or 155. For example, the trained diffusion model 150 determines, for each region of the noisy image, a corresponding view from the multiple rendered views depicted in the multi-view rendered image 125. In addition, the trained diffusion model 150 determines, for each particular region of the noisy image, a respective set of cross-frame attention features. For example, during iterative denoising of the noisy image, the trained diffusion model 150 determines the respective set of cross-frame attention features for each particular region based on one or more additional regions of the noisy image. In some cases, such as during one or more initial denoising iterations (e.g., a startup phase), the respective set of cross-frame attention features is determined based on one or more additional rendered views depicted in the multi-view rendered image 125 (e.g., excluding the rendered view corresponding to the particular noisy region).

Continuing with the example twenty-five rendered views in the multi-view rendered image 125, the trained diffusion model 150 determines a first noisy region of the noisy image corresponding to a first rendered view and an additional noisy region corresponding to each of the additional twenty-four rendered views. In addition, the trained diffusion model 150 calculates, for the first noisy region, a respective set of cross-frame attention features from some or all of the additional noisy regions (e.g., excluding the first noisy region).

In some implementations, generating the diffusion-generated views in the multi-view diffusion-generated image 155 based on cross-frame attention features improves consistency of appearance among the diffusion-generated views. For example, denoising each particular region of the noisy image based on cross-frame attention features from additional regions of the noisy image can generate more consistent data values that describe the diffusion-generated views (or iterations thereof) that are depicted in the noisy image. In some implementations, generating the diffusion-generated views in the multi-view diffusion-generated image 155 based on cross-frame attention features calculated from one or more multi-view images improves efficient use of computing resources (e.g., reduced usage of processing or memory resources) for generating the diffusion-generated views. For example, generating a multi-view diffusion-generated image during a particular denoising operation can provide a visual appearance for multiple views of a 3D digital object more efficiently as compared to generating a particular visual appearance for a particular view of the 3D digital object based on multiple denoising operations, e.g., applying a denoising operation to each view individually.

Based on the multi-view diffusion-generated image 155, the texture data generation computing system 110 generates or modifies the texture data object 115. For example, the texture data generation computing system 110 calculates one or more texture data values that describe the visual appearance depicted in the multi-view diffusion-generated image 155 across the multiple diffusion-generated views. In addition, the texture data generation computing system 110 modifies the texture data object 115 to include the texture data values. In some cases, the texture data object 115 is a texture map, such as a 2D digital image that includes texture data specialized for application to a 3D digital object. Examples of texture data included in a texture map can include texels that indicate, for instance, a color or other texture characteristics that can be included on a surface of a 3D digital object to provide a particular appearance of the digital object. In FIG. 1, the texture data generation computing system 110 modifies the texture data object 115 to include texels (or other texture data structures) to include the texture data values calculated from the multi-view diffusion-generated image 155. In some cases, the texture data generation computing system 110 calculates the one or more texture data values based on one or more blending techniques. An example of a first blending technique can include averaging data values from a set (or subset) of the multiple diffusion-generated views in the multi-view diffusion-generated image 155. An example of a second blending technique can include identifying, from the multiple diffusion-generated views in the multi-view diffusion-generated image 155, one or more diffusion-generated views that are similar to a portion of the 3D mesh 105, such as a particular diffusion-generated view that is within a similarity threshold to a normal (e.g., perpendicular) of a particular triangle in the 3D mesh 105. Additional blending techniques (or combinations of techniques) could be used by the texture data generation computing system 110 to calculate the texture data values or to modify the texture data object 115 based on the calculated texture data values.

In some implementations, the texture data generation computing system 110 repeats one or more techniques for generating or modifying the texture data object 115. For example, in a first pass of multi-view texture generation techniques by the texture data generation computing system 110, the rendering engine 120 can create a first multi-view rendered image, e.g., the image 125, based on rendered views of the 3D mesh 105 having no texture data applied, or a default texture data applied (e.g., a default color). In addition, the trained diffusion model 150 can create a second multi-view diffusion-generated image, e.g., the image 155, based on the multiple rendered views depicting no texture, or the default texture. Furthermore, the texture data generation computing system 110 can perform a first modification to the texture data object 115 based on the texture data values calculated from the multi-view diffusion-generated image 155. In a second pass of the multi-view texture generation techniques by the texture data generation computing system 110, the rendering engine 120 can create a third multi-view rendered image that is based on additional rendered views of the 3D mesh 105 having the first modified texture data from the texture data object 115. In addition, the trained diffusion model 150 can create a fourth multi-view diffusion-generated image based on the additional rendered views depicting the first modified texture data. Furthermore, the texture data generation computing system 110 can perform a second modification to the texture data object 115 based on additional texture data values calculated from the fourth multi-view diffusion-generated image. In a third pass of the multi-view texture generation techniques by the texture data generation computing system 110, the rendering engine 120 can create a sampling set of additional rendered views of the 3D mesh 105 having the second modified texture data from the texture data object 115. In some cases, the texture data generation computing system 110 can select from the sampling set a particular additional rendered view that lacks the second modified texture data, e.g., the particular additional rendered view was not included in the first or third multi-view rendered images. In addition, the trained diffusion model 150 can create one or more additional diffusion-generated views that depict an additional visual appearance for the particular additional rendered view. In some cases, the texture data generation computing system 110 could perform additional passes of the multi-view texture generation techniques (or portions of the techniques), such as to refine the modified texture data in the texture data object 115 or to create texture data for additional portions of the 3D digital object that lack texture data.

In the computing environment 100, the texture data generation computing system 110 provides the texture data object 115 to one or more additional computing systems, such as the additional computing device 190. In addition, the one or more additional computing systems are configured to modify at least one digital graphical environment based on the texture data object 115. For example, the additional computing device 190 receives the texture data object 115 from the texture data generation computing system 110. Responsive to receiving the texture data object 115, the additional computing device 190 modifies one or more digital graphical environments. For example, the additional computing device 190 generates a textured 3D digital object that is based on a combination of the 3D mesh 105 and the texture data object 115, e.g., the example apple object having a texture that is based on the requested visual appearance described by the appearance input data 107. In addition, the additional computing device 190 modifies one or more digital graphical environments to include the textured 3D digital object, such as modifying a VR collaboration environment to include the example apple object with the requested visual appearance. FIG. 1 describes the textured 3D digital object as being generated by the additional computing device 190 based on the texture data object 115, but other implementations are possible. For example, a texture data generation computing system could generate a textured 3D digital object based on a combination of a texture data object and a 3D mesh associated with the texture data object. In this example, the texture data generation computing system could provide the textured 3D digital object to one or more additional computing systems, such as additional computing systems configured to implement one or more digital graphical environments.

In some implementations, a texture data generation computing system includes at least one neural network that is trained to generate one or more images depicting a visual appearance of a particular 3D digital object. In some cases, the one or more images are generated based on a multi-view rendered image of the particular 3D digital object and appearance input data that indicates a requested visual appearance of the particular 3D digital object. In addition, the one or more images include diffusion-generated views of the particular 3D digital object, such as diffusion-generated views that each depict a combination of a particular view from the multi-view rendered image having a texture that is based on appearance input data, e.g., depicting the requested visual appearance. In some implementations, the trained neural network includes at least one trained diffusion image generation model. Additionally or alternatively, the trained neural network, e.g., via the included trained diffusion image generation model, generates or otherwise receives a set of cross-frame attention features for at least one rendered view in the multi-view rendered image of the particular 3D digital object. For example, the trained diffusion image generation model determines, for each particular rendered view in the multi-view rendered image, cross-frame attention features that describe relationships among the additional rendered views (or a subset thereof) in the multi-view rendered image.

In some cases, the trained diffusion image generation model improves consistency among the diffusion-generated views of the particular 3D digital object by utilizing one or more of the multi-view rendered image or the cross-frame attention features. For example, based on the cross-frame attention features, the trained diffusion image generation model can calculate image data with high consistency across the diffusion-generated views, such as image data that depicts a consistent visual appearance, e.g., to a human viewer, of the particular 3D digital object. In addition, based on a combination of the multi-view rendered image and the cross-frame attention features, the trained diffusion image generation model can calculate consistent image data across the diffusion-generated views simultaneously (or nearly simultaneously), e.g., all of the diffusion-generated views are modified during a particular application of diffusion-generation techniques by the trained model. In some cases, determining diffusion-generated views simultaneously (or nearly simultaneously) improves consistency by reducing or eliminating changes to sequentially calculated images data, e.g., “drift” of data values calculated over sequential views. Examples of consistent image data can include color data that is similar among multiple diffusion-generated views depicting similar portions of the particular 3D digital object, brightness data that is similar among multiple diffusion-generated views depicting object portions at a similar angle (e.g., lower brightness in an interior of a cardboard box object), color data having a visually coherent gradient among multiple diffusion-generated views depicting object portions with dissimilar colors (e.g., smooth color transitions across a leaf object, sharp color transitions across a beach ball object), or other types of image data depicting a consistent visual appearance among multiple diffusion-generated views depicting portions of the particular 3D digital object.

In some cases, the trained diffusion image generation model improves efficiency of one or more computing resources (e.g., processing resources, memory resources) by utilizing one or more of the multi-view rendered image or the cross-frame attention features. For example, based on the multi-view rendered image, the trained diffusion image generation model can determine the diffusion-generated views for all of the rendered views simultaneously (or nearly simultaneously), e.g., all of the diffusion-generated views are modified during a particular application of diffusion-generation techniques by the trained model. In some cases, determining diffusion-generated views simultaneously (or nearly simultaneously) for multiple portions of the particular 3D digital object reduces usage of computing resources as compared to contemporary approaches for determining diffusion-generated views sequentially for multiple portions of a 3D digital object.

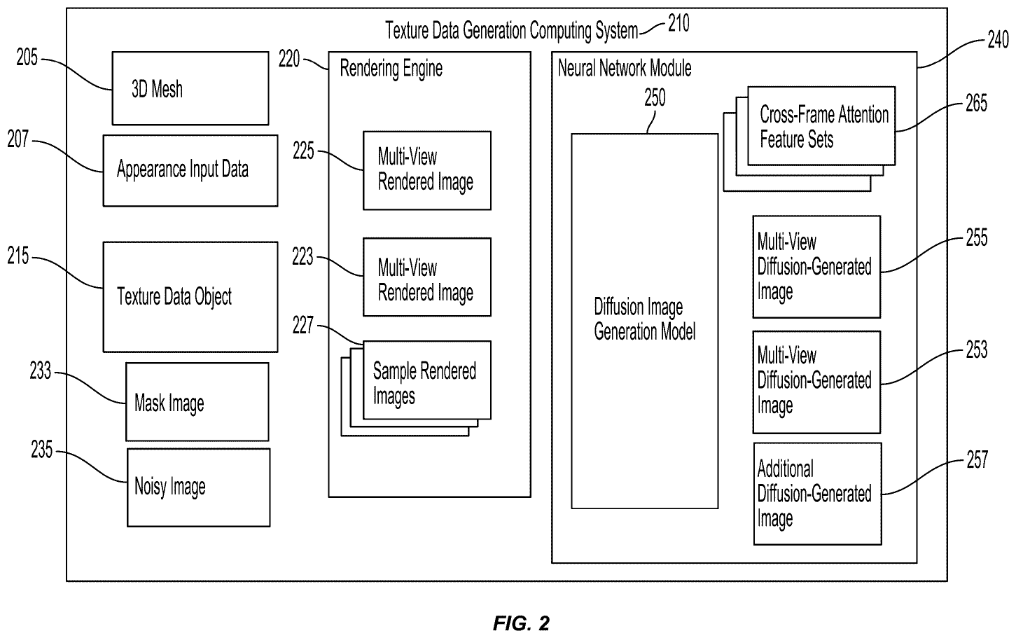

FIG. 2 depicts an example of a texture data generation computing system 210 that is configured to generate texture data for 3D digital objects. The texture data generation computing system 210 includes one or more of a rendering engine 220 or a neural network module 240. In addition, the neural network module includes at least one diffusion image generation model, such as a trained diffusion image generation model 250 (also referred to herein as the “diffusion model 250”). The diffusion model 250 is trained to generate 2D digital images depicting multiple diffusion-generated views of a visual appearance for a 3D digital object. Based on the 2D digital images from the trained diffusion model 250, the texture data generation computing system 210 generates texture data, such as a texture data object 215, describing the visual appearance depicted in the multiple diffusion-generated views. In some cases, the texture data generation computing system 210 is configured to perform multiple passes of texture-generation techniques, such as multiple passes to generate multiple sets of diffusion-generated views or texture data. In some implementations, the texture data generation computing system 210 is configured to communicate with one or more additional computing systems, such as the additional computing device 190 described in regard to FIG. 1. For example, the texture data generation computing system 210 can provide the texture data object 215, or a textured 3D digital object having the texture described by the texture data object 215, to an additional computing system that is configured to modify a digital graphical environment based on the texture data object 215 or the textured 3D digital object.

In FIG. 2, the texture data generation computing system 210 receives one or more of a 3D mesh 205 or appearance input data 207. In some cases, the 3D mesh 205 includes data describing a 3D digital object, such as triangle data describing a surface of the 3D digital object. In addition, the appearance input data 207 includes data describing a requested appearance for the 3D digital object, such as text data describing the requested appearance. In FIG. 2, the appearance input data 207 excludes texture data structures configured to be included on a surface of the 3D digital object, e.g., texels that can be applied during rendering of the 3D mesh 205. In some cases, the texture data generation computing system 210 generates or otherwise identifies one or more of the 3D mesh 205 or the appearance input data 207 based on request data received from an additional computing system, such as an additional computing system configured to implement a digital graphical environment.

In the texture data generation computing system 210, the rendering engine 220 generates multiple multi-view rendered digital images based on the 3D mesh 205. For example, the rendering engine 220 generates a first multi-view rendered image 225 that includes a first set of multiple rendered views of the 3D digital object described by the 3D mesh 205. In some cases, the first multi-view rendered image 225 is a 2D composite image in which the first set of rendered views are arranged in an array or another suitable arrangement. In addition, the first multi-view rendered image 225 depicts the 3D digital object having no texture, or having a default texture (e.g., default values which are not based on the appearance input data 207). In some cases, the rendering engine 220 generates the first multi-view rendered image 225 during a first pass of texture-generation techniques performed by the texture data generation computing system 210, such as a first pass to generate initial texture data.

Based on the first multi-view rendered image 225, the texture data generation computing system 210 generates a mask image 233. In some cases, the mask image 233 is a 2D image depicting a modification of the first set of multiple rendered views, such as a modification that depicts the first set of views in black and white or greyscale. In addition, the mask image 233 has one or more image characteristics, e.g., image size or image resolution, that are based on the first multi-view rendered image 225. For example, responsive to determining that the first multi-view rendered image 225 has an image size of 2000×2000 pixels, the texture data generation computing system 210 generates the mask image 233 having an image size of 2000×2000 pixels. In addition, responsive to determining that the first multi-view rendered image 225 includes twenty-five rendered views arranged in a 5×5 array, the texture data generation computing system 210 generates the mask image 233 having twenty-five mask regions arranged in a 5×5 array, such that each particular rendered view has a corresponding mask region.

Based on the first multi-view rendered image 225, the texture data generation computing system 210 generates a noisy image 235. In some cases, the noisy image 235 is a 2D image that depicts digital noise. An example of digital noise for a 2D digital image can include pixel characteristics (e.g., color, brightness) that are determined via a Gaussian distribution (e.g., Gaussian noise). An additional example of digital noise for a 2D digital image can include vector characteristics, such as data values that are determined via a Gaussian distribution and included in a vector representation (e.g., feature space) of a 2D digital image. In some cases, the noisy image 235 is associated with a vector representation. For example, the texture data generation computing system 210 can generate the noisy image 235 as a solid white image having an image size or resolution based on the first multi-view rendered image 225, e.g., an image size of 2000×2000 pixels. In addition, the texture data generation computing system 210 can generate a vector representation associated with the noisy image 235 that includes digital noise, e.g., modified vector values that are determined via a Gaussian distribution, such that the noisy vector representation indicates a white image that has Gaussian noise. In some cases, the vector representation (or noisy vector representation) is generated by or stored in the neural network module 240 or the trained diffusion image generation model 250.

In the texture data generation computing system 210, the trained diffusion model 250 generates multiple multi-view diffusion-generated digital images. In FIG. 2, the multi-view diffusion-generated images are generated based on one or more of the mask image 233, the noisy image 235, the appearance input data 207, or one or more multi-view rendered digital images from the rendering engine 220. In some cases, the multi-view diffusion-generated images are generated based on one or more cross-frame attention features, such as one or more cross-frame attention feature sets determined during diffusion image generation techniques performed by the trained diffusion model 250. For example, the trained diffusion model 250 generates a first multi-view diffusion-generated image 255 that includes a first set of multiple diffusion-generated views of the 3D digital object having a visual appearance based on the appearance input data 207. In addition, the trained diffusion model 250 generates one or more sets of cross-frame attention features, such as cross-frame attention feature sets 265. In some cases, such as during the first pass of texture-generation techniques, the trained diffusion model 250 generates one or more of the first multi-view diffusion-generated image 255 or the cross-frame attention feature sets 265 based on receiving one or more of the mask image 233 or the appearance input data 207 as input.

In some implementations, the trained diffusion model 250 generates the first multi-view diffusion-generated image 255 by modifying the noisy image 235 or the associated noisy vector representation, such as modifications via iterative denoising operations. During one or more iterations of the denoising operations, the trained diffusion model 250 determines a set of cross-frame attention features for one or more diffusion-generated views that are being generated, e.g., cross-frame attention feature sets corresponding to noisy regions of the noisy image 235. In some cases, the trained diffusion model 250 generates or modifies the cross-frame attention feature sets 265 for each denoising iteration (or a subset of denoising iterations) during the diffusion image generation techniques, such as by modifying one or more layers of the trained diffusion model 250 to include one or more current cross-frame attention features calculated during a current denoising iteration.

In the texture data generation computing system 210, the trained diffusion model 250 determines a respective set in the cross-frame attention feature sets 265 for each particular diffusion-generated view in the first multi-view diffusion-generated image 255. For example, the trained diffusion model 250 determines, for a particular noisy region of the noisy image 235, a corresponding cross-frame attention feature set in the sets 265. In addition, the corresponding cross-frame attention feature set includes data describing one or more relationships among additional mask regions corresponding to additional noisy regions of the noisy image 235. Based on the corresponding cross-frame attention feature set, the trained diffusion model 250 modifies the particular noisy region to include image features that are based, at least in part, on additional image features of the additional mask regions or the additional noisy regions. In some cases, such as during one or more initial denoising iterations (e.g., a startup phase), the corresponding cross-frame attention feature set is determined based on one or more additional rendered views depicted in the first multi-view rendered image 225 (e.g., excluding a particular rendered view corresponding to the particular noisy region).

In FIG. 2, the first multi-view diffusion-generated image 255 is a 2D image that includes 2D diffusion-generated views corresponding to the multiple rendered views depicted in the first multi-view rendered image 225, such as twenty-five diffusion-generated views arranged in a 5×5 array, such that each particular diffusion-generated view has a corresponding mask region in the mask image 233 and a corresponding rendered view in the first multi-view rendered image 225. In addition, the first multi-view diffusion-generated image 255 has one or more image characteristics that are based on the first multi-view rendered image 225, the mask image 233, or the noisy image 235, such an image size of 2000×2000 pixels. In some cases, the trained diffusion model 250 generates the first multi-view diffusion-generated image 255 during the first pass of texture-generation techniques performed by the texture data generation computing system 210. For example, based on a combination of the appearance input data 207 with the first multi-view rendered image 225 (or the mask image 233), the first set of multiple diffusion-generated views in the first multi-view diffusion-generated image 255 depicts the 3D digital object having an initial texture that is based on the visual appearance described by the appearance input data 207.

Based on the first multi-view diffusion-generated image 255, the texture data generation computing system 210 performs a first modification to the texture data object 215. For example, the texture data generation computing system 210 calculates first texture data values that describe the initial texture appearance depicted in the first multi-view diffusion-generated image 255 across the first set of multiple diffusion-generated views. In addition, the texture data generation computing system 210 modifies the texture data object 215 to include texels (or other texture data structures) that are based on the first texture data values calculated from the first multi-view diffusion-generated image 255. In some cases, the texture data generation computing system 210 performs the first modification to the texture data object 215 during the first pass of texture-generation techniques performed by the texture data generation computing system 210. For example, based on a first blending technique for averaging data values from a set (or subset) of the multiple diffusion-generated views in the first multi-view diffusion-generated image 255, the texture data generation computing system 210 calculates the first texture data values. In addition, based on the first pass techniques, the first modified texture data object 215 includes the first texture data values that describe the initial texture depicted in the first multi-view diffusion-generated image 255.

In FIG. 2, the texture data generation computing system 210 performs one or more additional passes of texture-generation techniques, such as a second pass that is based on the first modified texture data object 215. For example, the rendering engine 220 generates a second multi-view rendered image 223 that includes a second set of multiple rendered views of the 3D digital object described by the 3D mesh 205. In addition, the second multi-view rendered image 223 depicts the 3D digital object having the initial texture described by the first modified texture data object 215. In addition, the second multi-view rendered image 223 is a 2D composite image in which the second set of rendered views are arranged in an array or another suitable arrangement. In some cases, the rendering engine 220 generates the second multi-view rendered image 223 during a second pass of texture-generation techniques performed by the texture data generation computing system 210, such as a second pass to generate refined texture data.

In the texture data generation computing system 210, the multiple multi-view rendered images 225 and 223 are generated based on a particular set of views for the 3D mesh 205, such that the multi-view rendered images 225 and 223 depict a same set of views for the 3D digital object having different textures, e.g., no texture or default texture in the first multi-view rendered image 225, the initial texture from the first modified texture data object 215 in the second multi-view rendered image 223. In some cases, the particular set of views includes views selected at different viewpoints, such that each particular view depicts a different portion of the 3D digital object. Additionally or alternatively, the selected different viewpoints have different viewing angles of the 3D digital object and same (or similar) distances from the 3D digital object, such that each view in the particular set of views depicts a different portion of the 3D digital object from a same (or similar) viewpoint distance. Based on the multi-view rendered images 225 and 223 depicting the same set of views, the images 225 and 223 have some image characteristics that are the same, such as a same image size of 2000×2000 pixels and a same view arrangement of a 5×5 array. In FIG. 2, the multi-view rendered images 225 and 223 each depict a respective set of twenty-five rendered views, in which the depicted textures are different between the respective sets.

In some cases, during the second pass of texture-generation techniques performed by the texture data generation computing system 210, the texture data generation computing system 210 modifies the noisy image 235 or generates an additional version of the noisy image 235. During the second pass, the texture data generation computing system 210 generates or modifies the additional noisy image 235 as an additional solid white image having an image size or resolution based on the second multi-view rendered image 223, e.g., an image size of 2000×2000 pixels. In addition, the texture data generation computing system 210 generates or modifies an additional noisy vector representation associated with the additional noisy image 235.

Based on one or more of the second multi-view rendered image 223, the additional noisy image 235, or the appearance input data 207, the trained diffusion model 250 generates a second multi-view diffusion-generated image 253 that includes a second set of multiple diffusion-generated views of the 3D digital object having a visual appearance based on the second multi-view rendered image 223 or a combination of the second multi-view rendered image 223 and the appearance input data 207. In addition, the trained diffusion model 250 generates or modifies one or more sets of cross-frame attention features, such as modifying the cross-frame attention feature sets 265. In some cases, the trained diffusion model 250 generates the second multi-view diffusion-generated image 253 by modifying the additional noisy image 235 or the associated additional noisy vector representation, such as modifications via iterative denoising operations. In addition, the trained diffusion model 250 determines a respective set in the cross-frame attention feature sets 265 for each particular diffusion-generated view in the second multi-view diffusion-generated image 253. For example, the trained diffusion model 250 determines, for a particular noisy region of the additional noisy image 235, a corresponding cross-frame attention feature set in the sets 265. In some cases, such as during the second pass of texture-generation techniques, the trained diffusion model 250 generates or modifies one or more of the second multi-view diffusion-generated image 253 or the cross-frame attention feature sets 265 based on receiving one or more of the second multi-view rendered image 223 or the appearance input data 207 as input.

In FIG. 2, the second multi-view diffusion-generated image 253 is a 2D image that includes 2D diffusion-generated views corresponding to the multiple rendered views depicted in the second multi-view rendered image 223, such as twenty-five diffusion-generated views arranged in a 5×5 array, such that each particular diffusion-generated view has a corresponding rendered view in the second multi-view rendered image 223. In addition, the second multi-view diffusion-generated image 253 has one or more image characteristics that are based on the second multi-view rendered image 223 or the additional noisy image 235, such an image size of 2000×2000 pixels. In some cases, the trained diffusion model 250 generates the second multi-view diffusion-generated image 253 during the second pass of texture-generation techniques performed by the texture data generation computing system 210. For example, based on a combination of the appearance input data 207 with the second multi-view rendered image 223, the second set of multiple diffusion-generated views in the second multi-view diffusion-generated image 253 depicts the 3D digital object having a refined texture that is based on a combination of the visual appearance described by the appearance input data 207 and the initial texture that is depicted in the second multi-view rendered image 223.

Based on the second multi-view diffusion-generated image 253, the texture data generation computing system 210 performs a second modification to the texture data object 215. For example, the texture data generation computing system 210 calculates second texture data values that describe the refined texture appearance depicted in the second multi-view diffusion-generated image 253 across the second set of multiple diffusion-generated views. In addition, the texture data generation computing system 210 modifies the texture data object 215 to include texels (or other texture data structures) that are based on the second texture data values calculated from the second multi-view diffusion-generated image 253. In some cases, the texture data generation computing system 210 performs the second modification to the texture data object 215 during the second pass of texture-generation techniques performed by the texture data generation computing system 210. For example, based on a second blending technique for identifying a similarity between a particular diffusion-generated view and a particular triangle in the 3D mesh 205, the texture data generation computing system 210 calculates the second texture data values. In some cases, the second blending technique includes identifying, from the multiple diffusion-generated views in the second multi-view diffusion-generated image 253, one or more particular diffusion-generated views that are within a similarity threshold to a normal (e.g., perpendicular) of the particular triangle in the 3D mesh 205. In addition, based on the second pass techniques, the second modified texture data object 215 includes the second texture data values that describe the refined texture depicted in the second multi-view diffusion-generated image 253.

In FIG. 2, the texture data generation computing system 210 performs an additional pass of texture-generation techniques, such as a third pass that is based on the second modified texture data object 215. For example, the rendering engine 220 generates a sampling set of rendered digital images, such as sample rendered images 227. In the texture data generation computing system 210, the sample rendered images 227 include multiple digital images, each of which depicts a rendered view of the 3D digital object described by the 3D mesh 205. In addition, the sample rendered images 227 depict the 3D digital object having the refined texture described by the second modified texture data object 215. In some cases, the set of rendered digital images in the sample rendered images 227 includes sampling rendered images that each depict a respective rendered view (e.g., the set excludes multi-view rendered images). In addition, the rendering engine 220 or the texture data generation computing system 210 selects, for inclusion in the sample rendered images 227, sampling rendered views that are different from the particular set of views for the 3D mesh 205 from which the multiple multi-view rendered images 225 and 223 are generated. For example, the rendering engine 220 may generate a group of multiple potential viewpoints for the sample rendered images 227. In some cases, the rendering engine 220 may modify the group of potential viewpoints to exclude one or more potential viewpoints that are within a threshold similarity of the particular set of views for the 3D mesh 205, such as a potential viewpoint having a viewing angle that is within a similarity threshold of an additional viewing angle in the particular set of views. Additionally or alternatively, the rendering engine 220 may modify the group of potential viewpoints to include one or more potential viewpoints that lack the second texture data values included in the second modified texture data object 215, such as a potential viewpoint in which the refined texture from the second pass is omitted from the 3D mesh 205. In some cases, the rendering engine 220 generates the sample rendered images 227 during the third pass of texture-generation techniques performed by the texture data generation computing system 210, such as a third pass to generate infilled texture data, e.g., additional texture data generated to infill regions of the 3D digital object for which initial texture or refined texture was not generated during the first or second passes.

In some cases, during the third pass of texture-generation techniques performed by the texture data generation computing system 210, the texture data generation computing system 210 modifies the noisy image 235 or generates an additional version of the noisy image 235. During the third pass, the texture data generation computing system 210 generates or modifies the additional noisy image 235 as an additional solid white image having an image size or resolution based on a particular rendered image of the sample rendered images 227, e.g., an image size that matches an additional size of the particular rendered image. In addition, the texture data generation computing system 210 generates or modifies an additional noisy vector representation associated with the additional noisy image 235. In some cases, the texture data generation computing system 210 could generate respective noisy images or respective noisy vector representations for one or more of the sample rendered images 227, such as respective noisy images for a subset of the sampling rendered images having a threshold value of untextured appearance.

Based on one or more of the sample rendered images 227, the additional noisy image 235, or the appearance input data 207, the trained diffusion model 250 generates at least one additional diffusion-generated image 257. In FIG. 2, the additional diffusion-generated image 257 includes an additional diffusion-generated view of the 3D digital object having a visual appearance based on the refined texture described in the second modified texture data object 215, such as refined texture visible in additional rendered views depicted in the sample rendered images 227. In addition, the at least one additional diffusion-generated image 257 depicts the 3D digital object having an infilled texture that is based on a combination of multiple regions of the refined texture described in the second modified texture data object 215, e.g., multiple regions of refined texture visible in multiple images of the sample rendered images 227.

In some cases, the trained diffusion model 250 generates a respective diffusion-generated image for each rendered image in the sample rendered images 227 (or a subset thereof), such as respective diffusion-generated images that are generated sequentially. In addition, the trained diffusion model 250 generates or modifies one or more additional cross-frame attention features for the additional diffusion-generated image 257, such as additional cross-frame attention features indicating relationships among sequential respective diffusion-generated images. In some cases, limiting sequentially generated cross-frame attention features to the third pass by the texture data generation computing system 210 improves consistency of appearance among the sequentially diffusion-generated images while reducing impact on computing efficiency, e.g., reducing computing resource expenditure for sequentially generated diffusion-generated images.

Based on the at least one additional diffusion-generated image 257, the texture data generation computing system 210 performs a third modification to the texture data object 215. For example, the texture data generation computing system 210 calculates third texture data values that describe the infilled texture appearance depicted in the additional diffusion-generated image 257. In addition, the texture data generation computing system 210 modifies the texture data object 215 to include texels (or other texture data structures) that are based on the third texture data values calculated from the at least one additional diffusion-generated image 257. In some cases, the texture data generation computing system 210 performs the third modification to the texture data object 215 during the third pass of texture-generation techniques performed by the texture data generation computing system 210. In addition, based on the third pass techniques, the third modified texture data object 215 includes the third texture data values that describe the infilled texture depicted in the additional diffusion-generated image 257.

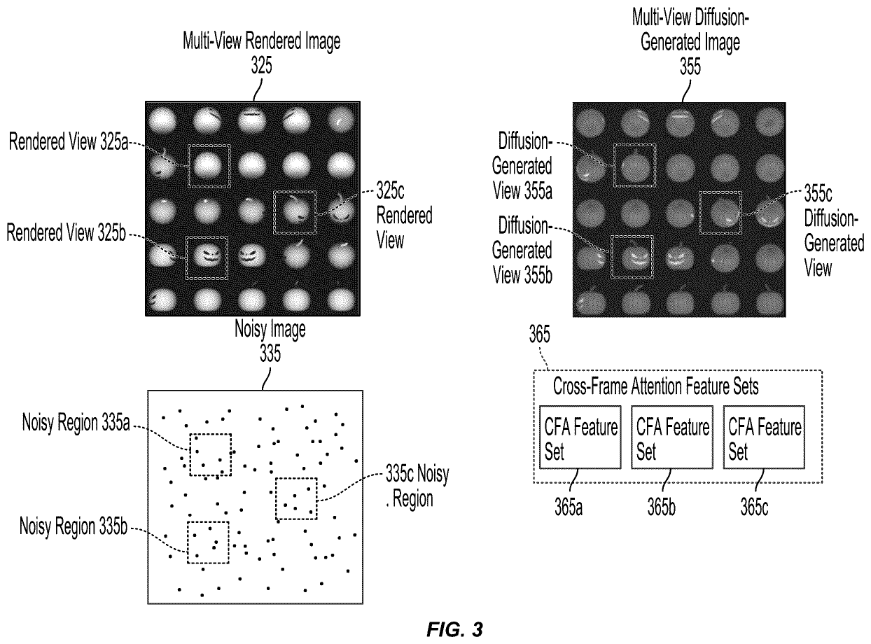

FIG. 3 is a diagram depicting examples of one or more data structures described herein, such as data structures related to generating texture data for 3D digital objects. FIG. 3 includes diagrammatic examples of a multi-view rendered image 325, a noisy image 335, a multi-view diffusion-generated image 355, and cross-frame attention feature sets 365. In some cases, the example data structures are generated by a texture data generation computing system, such as the texture data generation computing system 210. For example, the multi-view rendered image 325 is generated by a rendering engine, such as the rendering engine 220. In addition, one or more of the multi-view diffusion-generated image 355 or the cross-frame attention feature sets 365 are generated by a diffusion image generation model, such as the trained diffusion model 250. In addition, the noisy image 335 is generated by one or more of a texture data generation computing system or a neural network module, such as the texture data generation computing system 210 or the neural network module 240. The data structures depicted in FIG. 3 are diagrammatic examples to aid understanding of the techniques described herein. However, other implementations of the described data structures are possible, including data structures not intended for human interpretation.

In FIG. 3, the multi-view rendered image 325 includes multiple rendered views of an example 3D digital object, such as a jack-o-lantern object. In addition, the multi-view rendered image 325 is a 2D composite image of the multiple rendered views. For example, the multi-view rendered image 325 includes a 5×5 array of twenty-five rendered views, each particular region of the array depicting a respective rendered view of the jack-o-lantern object. In addition, the multi-view rendered image 325 includes regions depicting a first rendered view 325a, a second rendered view 325b, a third rendered view 325c, and additional regions depicting additional rendered views. In the multi-view rendered image 325, the multiple rendered views, including the rendered views 325a, 325b, and 325c, depict viewpoints having different viewing angles of the jack-o-lantern object and same (or similar) distances from the jack-o-lantern object, such that each particular rendered view depicts a different portion of the jack-o-lantern object from a same (or similar) viewpoint distance. In some cases, the multiple rendered views, including the views 325a, 325b, and 325c, are generated based on rendered views of a 3D mesh having no texture data applied, such as a untextured 3D mesh for the jack-o-lantern object.

In FIG. 3, the multi-view diffusion-generated image 355 includes multiple diffusion-generated views that are generated based on, at least, the multiple rendered views in the multi-view rendered image 325. In some cases, the multi-view diffusion-generated image 355 is generated based on a combination of some or all of the multi-view rendered image 325, a mask image generated based on the multi-view rendered image 325, the noisy image 335, the cross-frame attention feature sets 365, or appearance input data. In addition, the multi-view diffusion-generated image 355 is a 2D image that includes 2D diffusion-generated views that correspond to the multiple rendered views depicted in the multi-view rendered image 325, each of the 2D diffusion-generated views having a visual appearance, such as a visual appearance that corresponds to appearance input data or texture data included in a texture data object (such as the texture data object 215 or modified versions thereof). For example, the multi-view diffusion-generated image 355 includes a 5×5 array of twenty-five diffusion-generated views, each particular region of the array depicting a respective diffusion-generated view of the jack-o-lantern object having a visual appearance based on a requested visual appearance, such as “orange with a green stem” and “lighted from within.” In addition, the multi-view diffusion-generated image 355 includes regions depicting a first diffusion-generated view 355a corresponding to the first rendered view 325a, a second diffusion-generated view 355b corresponding to the second rendered view 325b, a third diffusion-generated view 355c corresponding to the third rendered view 325c, and additional regions depicting additional diffusion-generated views corresponding to additional respective rendered views of the multi-view rendered image 325.

In some implementations, the multi-view diffusion-generated image 355 is generated based on the noisy image 335 or the cross-frame attention feature sets 365. In some cases, the noisy image 335 is a 2D image that depicts digital noise, such as Gaussian noise. In addition, the noisy image 335 is associated with a vector representation, such as a noisy vector representation. In FIG. 3, the noisy image 335 is generated based on the multi-view rendered image 325. For example, if the multi-view rendered image 325 has an image size of 2000×2000 pixels, the noisy image 335 is generated (or modified) having an image size of 2000×2000 pixels. In addition, the noisy image 335 includes noisy regions corresponding to the rendered views in the multi-view rendered image 325, such as a 5×5 array of twenty-five noisy regions corresponding to the twenty-five rendered views. For example, the noisy image 335 includes a first noisy region 335a corresponding to the first rendered view 325a, a second noisy region 335b corresponding to the second rendered view 325b, a third noisy region 335c corresponding to the third rendered view 325c, and additional noisy regions corresponding to additional respective rendered views of the multi-view rendered image 325. In FIG. 3, the diffusion-generated views in the multi-view diffusion-generated image 355 are generated via one or more modifications (e.g., iterative denoising operations) to corresponding noisy regions in the noisy image 335. For example, the first diffusion-generated view 355a is generated based on the corresponding first noisy region 335a, the second diffusion-generated view 355b is generated based on the corresponding second noisy region 335b, the third diffusion-generated view 355c is generated based on the corresponding third noisy region 335c, and additional diffusion-generated views in the multi-view diffusion-generated image 355 are generated based on corresponding additional noisy regions in the noisy image 335. FIG. 3 depicts the noisy image 335 as including visual noise that is visible to a human, but other implementations are possible. For example, a noisy image could depict Gaussian noise, white noise, or other types of noise. Additionally or alternatively, a noisy image could depict an image (e.g., a solid white image, a solid black image, a solid color image) that is associated with a noisy vector representation, e.g., a vector representation of Gaussian noise, white noise, or other types of noise.

In some implementations, the multi-view diffusion-generated image 355 is generated based on the cross-frame attention feature sets 365. In some cases, each cross-frame attention feature set in the sets 365 describes image features, or relationships among image features, in a corresponding image region. In FIG. 3, each cross-frame attention feature set in the sets 365 corresponds to a particular region in the multi-view diffusion-generated image 355, each region depicting a particular diffusion-generated view. For example, the cross-frame attention feature sets 365 includes a first cross-frame attention feature set 365a corresponding to the first diffusion-generated view 355a, a second cross-frame attention feature set 365b corresponding to the second diffusion-generated view 355b, a third cross-frame attention feature set 365c corresponding to the third diffusion-generated view 355c, and additional cross-frame attention feature sets corresponding to additional respective diffusion-generated views of the multi-view diffusion-generated image 355. In addition, each cross-frame attention feature set in the sets 365 is generated based on additional regions, e.g., not including the corresponding region, from one or more of the multi-view rendered image 325, a mask image corresponding to the multi-view rendered image 325, or the noisy image 335. For example, the first cross-frame attention feature set 365a includes features that are determined based on additional features of additional image regions, such as cross-frame attention features of the noisy regions 335b and 335c or corresponding mask regions, or cross-frame attention features of the rendered views 325b and 325c, e.g., excluding the corresponding noisy region 335a or the corresponding rendered view 325a. In addition, the second cross-frame attention feature set 365b includes features determined based on additional features of additional image regions, such as cross-frame attention features of the noisy regions 335a and 335c or the rendered views 325a and 325c, e.g., excluding the corresponding noisy region 335b or the corresponding rendered view 325b. Furthermore, the third cross-frame attention feature set 365c includes features determined based on additional features of additional image regions, such as cross-frame attention features of the noisy regions 335a and 335b or the rendered views 325a and 325b, e.g., excluding the corresponding noisy region 335c or the corresponding rendered view 325c. In some implementations, generating the diffusion-generated views in the multi-view diffusion-generated image 355 based on cross-frame attention features improves consistency of appearance among the diffusion-generated views, e.g., the diffusion-generated views 355a, 355b, and 355c have improved visual consistency based on the respective cross-frame attention feature sets 365a, 365b, and 365c.

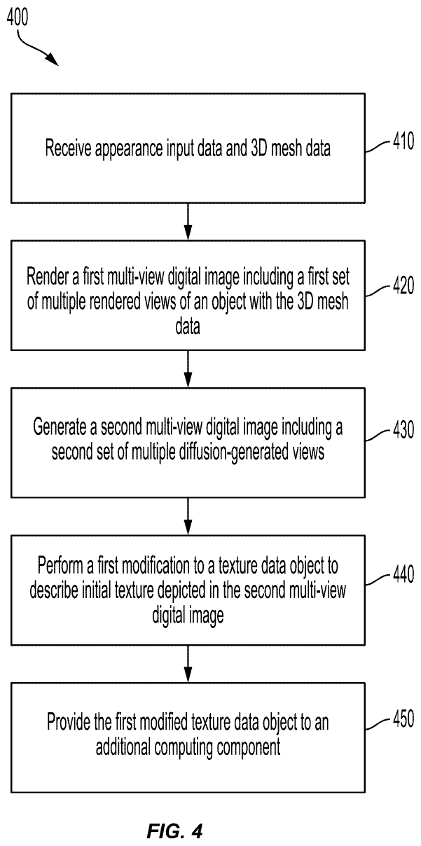

FIG. 4 is a flow chart depicting an example of a process 400 for generating texture data for 3D digital objects, such as via one or more pairs of multi-view digital images. In some embodiments, such as described in regards to FIGS. 1-3, a computing device executing a texture data generation computing system implements operations described in FIG. 4, by executing suitable program code. For illustrative purposes, the process 400 is described with reference to the examples depicted in FIGS. 1-3. Other implementations, however, are possible.

At block 410, the process 400 involves receiving, by a texture data generation computing system, one or more of appearance input data and 3D mesh data. In some cases, the 3D mesh data describes a 3D digital object. For example, the 3D mesh data can describe triangles that define a surface of the 3D digital object, such as vertices, planes, normals, or other triangle characteristics. In some cases, the appearance input data describes a visual appearance of the 3D digital object, such as a requested visual appearance provided by a user of the texture data generation computing system, e.g., a user of an additional computing device in communication with the texture data generation computing system. For example, the appearance input data can include text data, a 2D digital image (e.g., a digital photograph), or other types of non-texture data describing a requested visual appearance. In addition, the appearance input data can exclude texture data indicating texture characteristics that can be included on a surface of the 3D digital object, such as excluding texels, a texture map, or other texture data structures that are configured to be applied during rendering. For example, the texture data generation computing system 210 receives one or more of the 3D mesh 205 or the appearance input data 207. In addition, the appearance input data 207 includes text data describing a requested visual appearance and excludes texture data structures configured for application to the 3D mesh 205 during rendering.

At block 420, the process 400 involves rendering a first multi-view rendered digital image, such as by a rendering engine included in the texture data generation computing system. In addition, the first multi-view rendered digital image includes a first set of multiple rendered views depicting the 3D digital object, such as rendered views that exclude the visual appearance described by the appearance input data. For example, the rendering engine 220 generates, based on the 3D mesh 205, the multi-view rendered image 225 including a set of multiple rendered views. In some cases, the first set of multiple rendered views are untextured, such as rendered views of the 3D digital object having no texture applied, or a default texture that is uncorrelated with the appearance input data. For example, the rendering engine renders the first set of multiple rendered views based on the 3D mesh data having no texture data applied during rendering. In some cases, the first multi-view rendered digital image is a 2D composite image in which the first set of multiple rendered views are arranged in an array or other suitable arrangement.

At block 430, the process 400 involves generating a second multi-view diffusion-generated digital image, such as by a trained diffusion image generation model included in the texture data generation computing system. In addition, the second multi-view diffusion-generated digital image includes a second set of multiple diffusion-generated views depicting the 3D digital object, such as diffusion-generated views that depict an initial texture of the 3D digital object. In some cases, the trained diffusion image generation model generates the second multi-view diffusion-generated digital image based on a combination of the first multi-view rendered digital image and the appearance input data. For example, the trained diffusion model 250 generates the multi-view diffusion-generated image 255 based on a combination of the multi-view rendered image 225 and the appearance input data 207. In some cases, the trained diffusion image generation model generates the second set of multiple diffusion-generated views based on one or more cross-frame attention features, such as respective sets of cross-frame attention features for each view in the second set of multiple diffusion-generated views. In some cases, the second multi-view diffusion-generated digital image is a 2D image generated via the trained diffusion image generation model, in which the second set of multiple diffusion-generated views are arranged in an array or other suitable arrangement, which corresponds to the arrangement of the first set of multiple rendered views.

At block 440, the process 400 involves modifying a texture data object, such as a first modification that is performed by the texture data generation computing system, to describe the initial texture depicted in the second multi-view diffusion-generated digital image. In some cases, the first modification to the texture data object includes calculating one or more first texture data values that describe the initial texture. In addition, the first modification to the texture data object includes modifying one or more data structures of the texture data object, such as texels or other texture data structures, based on the first texture data values. For example, the texture data generation computing system 210 calculates one or more first texture data values that describe the initial texture depicted in the multi-view diffusion-generated image 255. In addition, the texture data generation computing system 210 modifies the texture data object 215 to include texels (or other texture data structures) that are based on the calculated first texture data values. In some cases, the texture data object is, or includes, a texture map. In some cases, the texture data generation computing system calculates the first texture data values via one or more blending techniques, such as a first blending technique involving averaging data values from some or all diffusion-generated views from the second set of multiple diffusion-generated views, or a second blending technique involving identifying, from the second set of multiple diffusion-generated views, one or more diffusion-generated views that are similar to a particular triangle in the 3D mesh data.

At block 450, the process 400 involves providing, by the texture data generation computing system, the first modified texture data object to at least one additional computing component. Based on the first modified texture data object, the additional computing component is configured to render at least one 3D digital object, such as the 3D digital object described by the 3D mesh data received by the texture data generation computing system. In some cases, the at least one additional computing component is a computing component that is included in the texture data generation computing system. For example, the texture data generation computing system 210 provides the first modified texture data object 215 to the rendering engine 220, such as to perform one or more additional passes of texture-generation techniques. Responsive to receiving the first modified texture data object 215, the rendering engine 220 renders at least one additional view of the 3D digital object described by the 3D mesh 205, such as rendered views included in the multi-view rendered image 223. In some cases, the at least one additional computing component is a computing component that is included in one or more additional computing systems. For example, the texture data generation computing system 110 provides the modified texture data object 115 to the additional computing device 190. Responsive to receiving the modified texture data object 115, the additional computing device 190 modifies a digital graphical environment (or a local instance thereof) to include one or more 3D digital objects having the texture described by the texture data object 115.

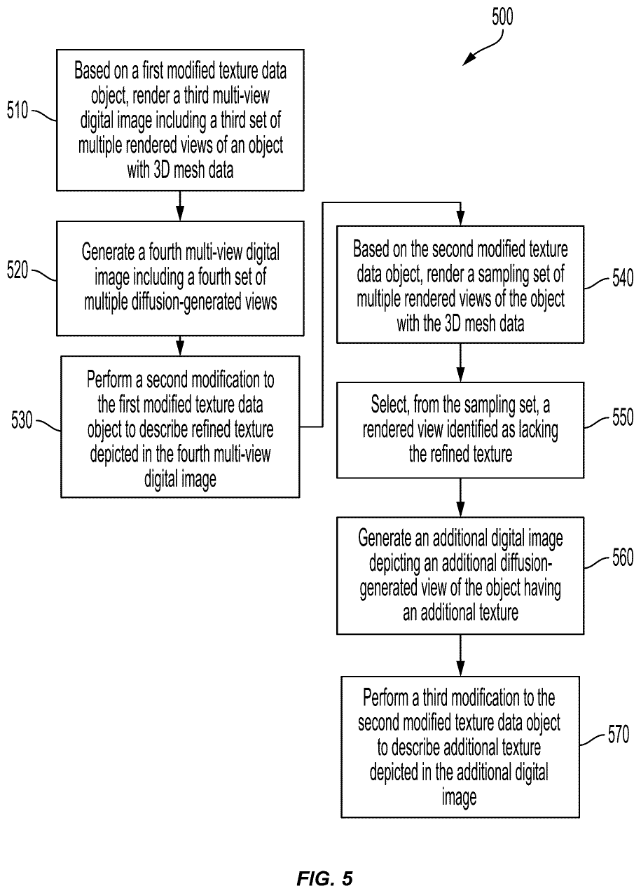

FIG. 5 is a flow chart depicting an example of a process 500 for generating refined texture data or infilled texture data for 3D digital objects, such as via multiple pairs of multi-view digital images. In some embodiments, such as described in regards to FIGS. 1-4, a computing device executing a texture data generation computing system implements operations described in FIG. 5, by executing suitable program code. For illustrative purposes, the process 500 is described with reference to the examples depicted in FIGS. 1-4. Other implementations, however, are possible.

In some implementations, one or more operations involved in the process 500 are performed by a texture data generation computing system, such as the example texture data generation computing system described in regard to FIG. 4. For example, the texture data generation computing system can generate the first modified texture data object as described in regard to block 440. In addition, the texture data generation computing system can provide the first modified texture data object to an additional computing component, such as the rendering engine, as described in regard to block 450. In some cases, one or more operations described in regard to FIG. 4 are associated with a first pass of texture-generation techniques performed by the example texture data generation computing system, such as a first pass to generate initial texture data. In some cases, the example texture data generation computing system is configured to perform one or more additional passes of texture-generation techniques, such as one or more of a second pass to generate refined texture data or a third pass to generate infilled texture data. For example, the example texture data generation computing system described in FIG. 4 (or an additional texture data generation computing system) can be configured to perform one or more additional operations described in regard to FIG. 5, such as subsequent to one or more operations described in regard to FIG. 4.

At block 510, the process 500 involves rendering a third multi-view rendered digital image, such as by the rendering engine included in the example texture data generation computing system (or another rendering engine). In addition, the third multi-view rendered digital image includes a third set of multiple rendered views depicting the 3D digital object described by the 3D mesh data. In some cases, the rendering engine generates the third multi-view rendered digital image based on the first modified texture data object. In addition, the third set of multiple rendered views depict the 3D digital object having the initial texture described by the first modified texture data object. For example, based on a combination of the first modified texture data object 215 and the 3D mesh 205, the rendering engine 220 generates the multi-view rendered image 223 including a set of multiple rendered views. In addition, the rendered views in the multi-view rendered image 223 depict the 3D digital object described by the 3D mesh 205 having the initial texture described by the first modified texture data object 215. In some cases, the first multi-view rendered digital image and the third multi-view rendered digital image are generated based on a particular set of viewpoints, such as a set of viewpoints determined by the rendering engine.

At block 520, the process 500 involves generating a fourth multi-view diffusion-generated digital image, such as by the trained diffusion image generation model included in the texture data generation computing system (or another trained diffusion image generation model). In addition, the fourth multi-view diffusion-generated digital image includes a fourth set of multiple diffusion-generated views depicting the 3D digital object, such as diffusion-generated views that depict a refined texture of the 3D digital object. In some cases, the trained diffusion image generation model generates the fourth multi-view diffusion-generated digital image based on a combination of the third multi-view rendered digital image and the appearance input data. For example, the trained diffusion model 250 generates the multi-view diffusion-generated image 253 based on a combination of the multi-view rendered image 223 and the appearance input data 207. In some cases, the trained diffusion image generation model generates the fourth set of multiple diffusion-generated views based on one or more cross-frame attention features (or modified cross-frame attention features), such as respective sets of cross-frame attention features for each view in the fourth set of multiple diffusion-generated views. In some cases, the fourth multi-view diffusion-generated digital image is a 2D image generated via the trained diffusion image generation model, in which the fourth set of multiple diffusion-generated views are arranged in an array or other suitable arrangement, which corresponds to the arrangement of the third set of multiple rendered views.

At block 530, the process 500 involves modifying the texture data object, such as a second modification to the first modified texture data object that is performed by the texture data generation computing system, to describe the refined texture depicted in the fourth multi-view diffusion-generated digital image. In some cases, the second modification to the texture data object includes calculating one or more second texture data values that describe the refined texture. In addition, the second modification to the texture data object includes modifying one or more data structures of the texture data object, such as the texels or other data structures, based on the second texture data values. For example, the texture data generation computing system 210 calculates one or more second texture data values that describe the refined texture depicted in the multi-view diffusion-generated image 253. In addition, the texture data generation computing system 210 modifies (or further modifies) the first modified texture data object 215 to include texels (or other texture data structures) that are based on the calculated second texture data values. In some cases, the texture data generation computing system calculates the second texture data values via one or more blending techniques, such as one or more blending techniques described in regard to block 440. In addition, the texture data generation computing system could calculate the second texture data values based on a blending technique that is the same as, or different from, a blending technique used for calculating the first texture data values. For example, during the first pass of texture-generation techniques, the texture data generation computing system 210 performs the first modification to the texture data object 215 based on a first blending technique for averaging data values from the first multi-view diffusion-generated image 255. In addition, during the second pass of texture-generation techniques, the texture data generation computing system 210 performs the second modification to the texture data object 215 based on identifying, from the second multi-view diffusion-generated image 253, one or more particular diffusion-generated views that are within a similarity threshold to a normal of a particular triangle in the 3D mesh 205.

In some implementations, one or more operations described in regard to FIG. 5, such as blocks 510, 520, or 530, are associated with a second pass of texture-generation techniques performed by the example texture data generation computing system, such as a second pass to generate refined texture data.

At block 540, the process 500 involves rendering a sampling set of multiple rendered views, such as a sampling set of digital images rendered by the rendering engine in the example texture data generation computing system (or another rendering engine). In some cases, each rendered view in the sampling set is depicted by a respective digital image, such that the sampling set of digital images excludes multi-view rendered images. In addition, each rendered view in the sampling set depicts the 3D digital object described by the 3D mesh data. For example, the rendering engine 220 generates the sample rendered images 227, each of which depicts a respective rendered view of the 3D digital object described by the 3D mesh 205. In some cases, the rendering engine generates the sampling set of multiple rendered views based on the second modified texture data object. For example, each rendered view in the sampling set depicts the 3D digital object having the refined texture described by the second modified texture data object. For example, based on a combination of the second modified texture data object 215 and the 3D mesh 205, the rendering engine 220 generates the sample rendered images 227. In addition, the rendered views in the sample rendered images 227 depict the 3D digital object described by the 3D mesh 205 having the refined texture described by the second modified texture data object 215.

In some cases, the rendering engine or the texture data generation computing system generates the sampling set of multiple rendered views based on a group of multiple potential viewpoints. For example, the rendering engine selects, for inclusion in the sampling set, rendered views that are different (e.g., different viewing angles) from the views included in the first or third multi-view rendered digital images. In addition, the rendering engine selects, for inclusion in the sampling set of multiple rendered views, a particular rendered view based on a determination that the particular rendered view lacks texture data, e.g., omits the refined texture described by the second modified texture data object and the initial texture described by the first modified texture data object. For example, the rendering engine 220 generates the sample rendered images 227 based on a group of potential viewpoints modified to include one or more potential viewpoints that lack the second texture data values included in the second modified texture data object 215.

At block 550, the process 500 involves selecting, such as by the rendering engine or the texture data generation computing system, at least one rendered view from the sampling set of multiple rendered views. In addition, the at least one rendered view is identified, such as by the rendering engine or the texture data generation computing system, as lacking the refined texture from the second modified texture data object, or other texture data. For example, the texture data generation computing system determines that the rendered view, or respective digital image depicting the rendered view, depicts the 3D digital object as having at least a portion of untextured surface, e.g., the second modified texture data object omits texture data for the portion of the rendered surface. In addition, the texture data generation computing system determines that the portion of untextured surface in the rendered view fulfills a threshold value, e.g., the rendered view lacks texture data on a threshold portion of the surface visible in the view. For example, the texture data generation computing system 210 identifies, from the sample rendered images 227, one or more sampling rendered images that depict rendered views having a threshold value of untextured appearance. In addition, the texture data generation computing system 210 generates, for the identified sampling rendered images, respective noisy images or noisy vector representations.

At block 560, the process 500 involves generating, such as by the trained diffusion image generation model, at least one additional diffusion-generated digital image, such as a respective additional diffusion-generated digital image for each rendered view selected from the sampling set. In addition, the additional diffusion-generated digital image depicts an additional diffusion-generated view depicting the 3D digital object, such as an additional diffusion-generated view that depicts an additional texture of the 3D digital object. For example, the additional diffusion-generated view that depicts the 3D digital object having an infilled texture, such as a texture that is based on a combination of multiple regions of refined texture visible in the sampling set of multiple rendered views. In some cases, the trained diffusion image generation model generates the at least one additional diffusion-generated digital image based on a combination of the at least one selected rendered view with refined texture from the sampling set of multiple rendered views. For example, the trained diffusion model 250 generates the additional diffusion-generated image 257 based on a combination of a particular sampling rendered image from the sample rendered images 227 and refined texture visible in additional rendered images from the sample rendered images 227. In some cases, the trained diffusion image generation model generates the additional diffusion-generated digital image based on one or more cross-frame attention features (or modified cross-frame attention features), such as a respective cross-frame attention feature set for each additional diffusion-generated digital image corresponding to each rendered view selected for generation from the sampling set. In some cases, the additional diffusion-generated digital image is a 2D image generated via the trained diffusion image generation model, such as a particular diffusion-generated digital image depicting a particular diffusion-generated view, e.g., excluding multi-view diffusion-generated images.

At block 570, the process 500 involves modifying the texture data object, such as a third modification to the second modified texture data object performed by the texture data generation computing system, to describe the additional texture depicted in the at least one additional diffusion-generated digital image. In some cases, the third modification to the texture data object includes calculating one or more third texture data values that describe the additional texture, such as the infilled texture from the additional diffusion-generated digital image. In addition, the third modification to the texture data object includes modifying one or more data structures of the texture data object, such as the texels or other data structures, based on the third texture data values. For example, the texture data generation computing system 210 calculates one or more third texture data values that describe that describe the infilled texture appearance depicted in the additional diffusion-generated image 257. In addition, the texture data generation computing system 210 modifies (or further modifies) the second modified texture data object 215 to include texels (or other texture data structures) that are based on the calculated third texture data values.

In some implementations, one or more operations described in regard to FIG. 5, such as blocks 540, 550, 560, or 570, are associated with a third pass of texture-generation techniques performed by the example texture data generation computing system, such as a third pass to generate infilled texture data.

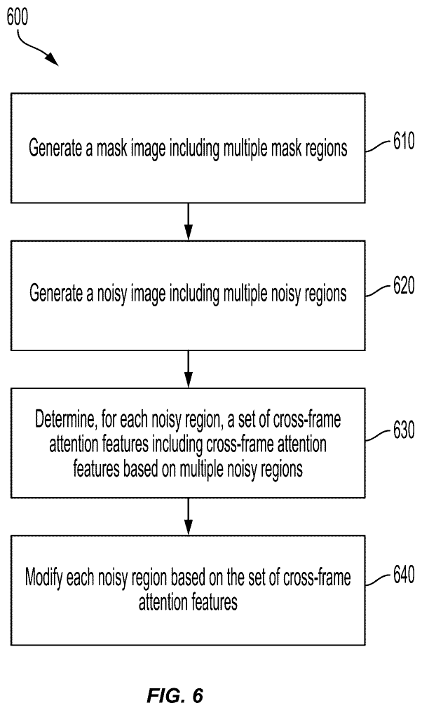

FIG. 6 is a flow chart depicting an example of a process 600 for generating texture data for 3D digital objects based on one or more cross-frame attention features, such as cross-frame attention features determined via a trained diffusion image generation model. In some embodiments, such as described in regards to FIGS. 1-5, a computing device executing a texture data generation computing system implements operations described in FIG. 6, by executing suitable program code. For illustrative purposes, the process 600 is described with reference to the examples depicted in FIGS. 1-5. Other implementations, however, are possible.

In some implementations, one or more operations involved in the process 600 are performed by a texture data generation computing system, such as the example texture data generation computing system described in regard to FIGS. 4 and/or 5. For example, the example diffusion image generation model included in the texture data generation computing system, such as described in regard to at least blocks 430 or 520, can be configured to determine one or more sets of cross-frame attention features. In some cases, one or more operations described in regard to the process 600 can be implemented by the example diffusion image generation model in regard to one or more operations of processes 400 and/or 500, such as generating one or more diffusion-generated digital images based on determination of one or more cross-frame attention feature sets, as described in regard to one or more of blocks 430, 520, or 560.

At block 610, the process 600 involves generating or modifying at least one mask image, such as by the example texture data generation computing system (or another texture data generation computing system). In addition, the at least one mask image is a 2D digital image generated by the texture data generation computing system (or a component thereof). In some cases, the at least one mask image is generated based on a multi-view rendered image, such as the first multi-view rendered digital image described in regard to block 420 or the third multi-view rendered digital image described in regard to block 520. For example, the texture data generation computing system 210 generates the mask image 233 based on the multi-view rendered image 225. In some cases, the at least one mask image has multiple mask regions, each of which corresponds to a respective view in the multi-view rendered image on which the mask image is based. For example, the mask image 233 has twenty-five mask regions respectively corresponding to the twenty-five rendered views in the multi-view rendered image 225. In addition, the at least one mask image has one or more image characteristics that are based on the multi-view rendered image or sampling rendered image. For example, responsive to determining that the multi-view rendered image 225 has an image size of 2000×2000 pixels, the texture data generation computing system 210 generates the mask image 233 having an image size of 2000×2000 pixels.

At block 620, the process 600 involves generating or modifying at least one noisy image, such as by the example texture data generation computing system (or another texture data generation computing system). In addition, the at least one noisy image is a 2D digital image generated by the texture data generation computing system (or a component thereof). In some cases, the at least one noisy image depicts digital noise or is associated with a noisy vector representation, such as a Gaussian distribution of digital noise. In some cases, the at least one noisy image has multiple noisy regions, each of which corresponds to a respective mask region in the mask image and to a respective view in the multi-view rendered image on which the mask image is based. For example, the texture data generation computing system 210 generates the noisy image 235 based on one or more of the mask image 233 or the multi-view rendered image 225. In addition, the noisy image 335 includes the noisy regions 335a, 335b, and 335c, each respectively corresponding to the rendered views 325a, 325b, and 325c in the multi-view rendered image 325. In some cases, the at least one noisy image has one or more image characteristics that are based on the multi-view rendered image or sampling rendered image corresponding to the at least one mask image. For example, responsive to determining that one or more of the multi-view rendered image 225 or the mask image 233 has an image size of 2000×2000 pixels, the texture data generation computing system 210 generates the noisy image 235 having an image size of 2000×2000 pixels.

At block 630, the process 600 involves determining or modifying one or more sets of cross-frame attention features, such as by the example diffusion image generation model (or another diffusion image generation model). In some cases, the diffusion image generation model determines a respective set of cross-frame attention features for each particular noisy region in the noisy image, or for each particular diffusion-generated view included in a multi-view diffusion-generated image generated based on the noisy image, such as the multi-view diffusion-generated images described in regard to one or more of blocks 430 or 520. For example, the trained diffusion model 250 determines the set of cross-frame attention features 265 corresponding to one or more of the multi-view diffusion-generated image 255 or the noisy image 235. In addition, the trained diffusion model 250 determines a respective set, in the cross-frame attention feature sets 265, for each particular diffusion-generated view in the multi-view diffusion-generated image 255 or each particular noisy region in the noisy image 235. In addition, each respective cross-frame attention feature set for a particular noisy region is generated (or modified) based on cross-frame features of one or more additional rendered views from the multi-view rendered digital image, or additional noisy regions from the corresponding noisy image. For example, the first cross-frame attention feature set 365a is generated for the corresponding diffusion-generated view 355a and corresponding noisy region 335a. In addition, the first cross-frame attention feature set 365a is generated based on the image features of the noisy regions 335b, 335c, and additional corresponding noisy regions in the noisy image 335 (or the corresponding diffusion-generated views 355b, 355c, and additional diffusion-generated views in the multi-view diffusion-generated image 355).

At block 640, the process 600 involves modifying one or more of the noisy regions in the at least one noisy image, such as by the diffusion image generation model. In some cases, the diffusion image generation model modifies each particular one of the noisy regions based on the respective set of cross-frame attention features for the particular noisy region. In some cases, the diffusion image generation model generates, from each particular modified noisy region, a respective diffusion-generated view in the multi-view diffusion-generated image. For example, the trained diffusion model 250 generates one or more of the multi-view diffusion-generated images 255 or 253 based on one or more modifications (e.g., iterative modifications) to the noisy image 235. In addition, the trained diffusion model 250 generates each particular diffusion-generated view in the multi-view diffusion-generated images 255 or 253 via respective modifications to the corresponding noisy regions. For instance, the diffusion-generated view 355a in the multi-view diffusion-generated image 355 is generated based on one or more modifications to the corresponding noisy region 335a. In addition, the diffusion-generated views 355b and 355c are respectively generated based on respective one or more modifications to the corresponding noisy regions 335b and 335c. In some cases, each particular modified noisy region depicts a texture, such as an initial texture or a refined texture, that is based on a set of cross-frame attention features corresponding to the particular noisy region.

In some implementations, one or more operations related to the process 600 are repeated, such as for iterative modifications to a noisy region by the example diffusion image generation model. For instance, the example diffusion image generation model could repeat modifications to the noisy image until some or all (e.g., a threshold quantity) of the noisy regions include respective diffusion-generated views depicting the initial texture or refined texture. In some cases, the example diffusion image generation model could repeat modifications to the noisy image until the respective diffusion-generated views have a particular image quality, such as fulfilling a threshold value for image resolution, a threshold quantity of iterations, or other example threshold data values for determining a particular quality for a diffusion-generated digital image.

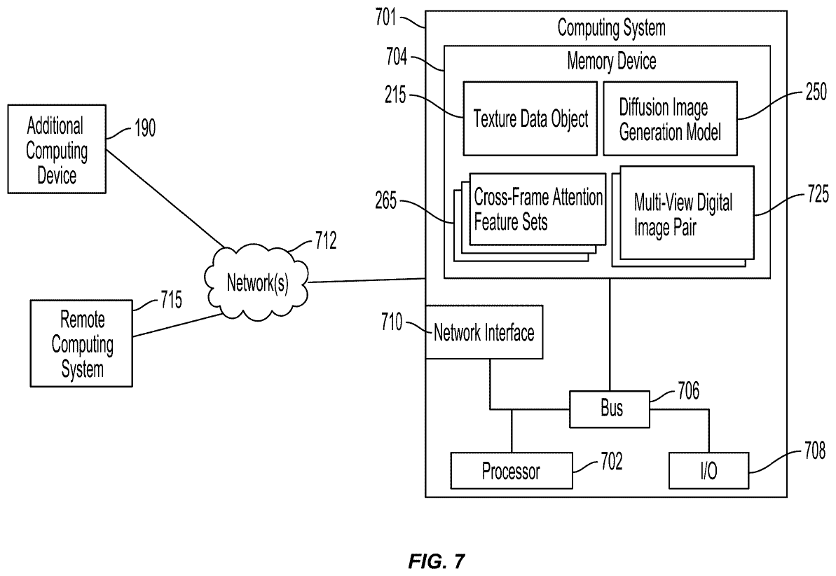

Any suitable computing system or group of computing systems can be used for performing the operations described herein. For example, FIG. 7 is a block diagram depicting a computing system that can be configured to implement a texture data generation computing system, according to certain embodiments.

The depicted example of a computing system 701 includes one or more processors 702 communicatively coupled to one or more memory devices 704. The processor 702 executes computer-executable program code or accesses information stored in the memory device 704. Examples of processor 702 include a microprocessor, an application-specific integrated circuit (“ASIC”), a field-programmable gate array (“FPGA”), or other suitable processing device. The processor 702 can include any number of processing devices, including one.

The memory device 704 includes any suitable non-transitory computer-readable medium for storing multi-view digital image pairs 725, the texture data object 215, the diffusion model 250, the cross-frame attention feature sets 265, and other received or determined values or data objects. In FIG. 7, the multi-view digital image pairs 725 includes at least one pair (or other quantity of corresponding multi-view images) of a multi-view rendered image and a corresponding multi-view diffusion-generated image, such as the multi-view rendered image 125 and the multi-view diffusion-generated image 155, the multi-view rendered image 225 and the multi-view diffusion-generated image 255, the multi-view rendered image 223 and the multi-view diffusion-generated image 253, or other pairs of multi-view digital images described herein. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 701 may also include a number of external or internal devices such as input or output devices. For example, the computing system 701 is shown with an input/output (“I/O”) interface 708 that can receive input from input devices or provide output to output devices. A bus 706 can also be included in the computing system 701. The bus 706 can communicatively couple one or more components of the computing system 701.

The computing system 701 executes program code that configures the processor 702 to perform one or more of the operations described above with respect to FIGS. 1-6. The program code includes operations related to, for example, one or more of the multi-view digital image pairs 725, the texture data object 215, the diffusion model 250, the cross-frame attention feature sets 265, or other suitable applications or memory structures that perform one or more operations described herein. The program code may be resident in the memory device 704 or any suitable computer-readable medium and may be executed by the processor 702 or any other suitable processor. In some embodiments, the program code described above, the multi-view digital image pairs 725, the texture data object 215, the diffusion model 250, and the cross-frame attention feature sets 265 are stored in the memory device 704, as depicted in FIG. 7. In additional or alternative embodiments, one or more of the multi-view digital image pairs 725, the texture data object 215, the diffusion model 250, the cross-frame attention feature sets 265, or the program code described above are stored in one or more memory devices accessible via a data network, such as a memory device accessible via a cloud service.

The computing system 701 depicted in FIG. 7 also includes at least one network interface 710. The network interface 710 includes any device or group of devices suitable for establishing a wired or wireless data connection to one or more data networks 712. Non-limiting examples of the network interface 710 include an Ethernet network adapter, a modem, and/or the like. A remote computing system 715 is connected to the computing system 701 via the data networks 712, and the remote computing system 715 can perform some of the operations described herein, such as rendering multi-view rendered digital images or sampling rendered digital images. The computing system 701 is able to communicate with one or more additional computing systems, such as the remote computing system 715 and the additional computing device 190, using the network interface 710.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method for generating a texture data object, the method comprising:
receiving appearance input data and a three-dimensional (“3D”) mesh describing a digital object;
rendering, via a rendering engine, a first multi-view rendered image of the digital object, wherein the first multi-view rendered image includes a first set of multiple rendered views depicting the digital object and excluding the appearance input data;
generating, via a trained neural network implementing a diffusion model, a second multi-view diffusion-generated image of the digital object, wherein the second multi-view diffusion-generated image includes a second set of multiple diffusion-generated views depicting the digital object having an initial texture, wherein the trained neural network generates the second multi-view diffusion-generated image of the digital object based on a combination of the first multi-view rendered image and the appearance input data;
performing a first modification to a texture data object to describe the initial texture depicted in the second multi-view diffusion-generated image, wherein the first modified texture data object includes first data values that are calculated based on the initial texture; and
providing the first modified texture data object to an additional computing component configured to, responsive to receiving the first modified texture data object, render the digital object having the initial texture described by the first modified texture data object.

2. The method of claim 1, further comprising:
generating a mask image based on the first multi-view rendered image, wherein the mask image includes multiple mask regions; and
generating a noisy image, wherein the noisy image includes multiple noisy regions,
wherein, in the first multi-view rendered image, each particular rendered view included in the first set of multiple rendered views corresponds to i) a respective mask region of the multiple mask regions and ii) a respective noisy region of the multiple noisy regions,
wherein the trained neural network implementing the diffusion model is further configured for:
determining, for each respective noisy region of the multiple noisy regions, a respective set of cross-frame attention features, the respective set of cross-frame attention features including at least one cross-frame attention feature for one or more additional noisy region of the multiple noisy regions; and
modifying each respective noisy region based on the respective set of cross-frame attention features,
wherein, in the second multi-view diffusion-generated image, each particular diffusion-generated view included in the second set of multiple diffusion-generated views depicts a respective initial texture that is generated based on a corresponding set of cross-frame attention features for a corresponding noisy region of the multiple noisy regions.

3. The method of claim 1, wherein performing the first modification to the texture data object further comprises:
for each particular diffusion-generated view in the second set of multiple diffusion-generated views:
determining a respective texture data value describing a respective initial texture depicted by the particular diffusion-generated view; and
calculating a respective average data value that is based on a combination of i) the respective texture data value associated with the particular diffusion-generated view and ii) at least one additional respective texture data value associated with at least one additional particular diffusion-generated view in the second set of multiple diffusion-generated views,
wherein the first data values are calculated based on the respective average data value for each particular diffusion-generated view in the second set of multiple diffusion-generated views.

4. The method of claim 1, further comprising:
rendering, via the rendering engine, a third multi-view rendered image of the digital object, wherein the third multi-view rendered image includes a third set of multiple rendered views depicting the digital object having the initial texture described by the first modified texture data object;
generating, via the trained neural network implementing the diffusion model, a fourth multi-view diffusion-generated image of the digital object, wherein the fourth multi-view diffusion-generated image includes a fourth set of multiple diffusion-generated views depicting the digital object having a refined texture; and
performing a second modification to the first modified texture data object to describe the refined texture depicted in the fourth multi-view diffusion-generated image, wherein the second modified texture data object includes second data values that are calculated based on the refined texture.

5. The method of claim 4, wherein the trained neural network generates the fourth multi-view diffusion-generated image of the digital object based on a denoising technique applied to the third multi-view rendered image.

6. The method of claim 4, wherein the rendering engine is configured to render the first set of multiple rendered views and the third set of multiple rendered views using a same set of viewpoints of the 3D mesh.

7. The method of claim 4, wherein performing the second modification to the first modified texture data object further comprises:
for each particular triangle included in the 3D mesh:
identifying, from the fourth set of multiple diffusion-generated views, a particular diffusion-generated view having a viewing direction that is within a similarity threshold to a normal of the particular triangle; and
determining a respective texture data value describing a respective refined texture depicted by the particular diffusion-generated view,
wherein the second data values are calculated based on the respective texture data value for each particular triangle included in the 3D mesh.

8. The method of claim 4, further comprising:
rendering, via the rendering engine, a sampling set of multiple rendered views depicting the 3D mesh for the digital object having the refined texture described by the second modified texture data object;
selecting, from the sampling set, at least one rendered view that is identified as omitting the refined texture;
generating, via the trained neural network implementing the diffusion model, an additional image depicting an additional diffusion-generated view, the additional diffusion-generated view depicting the digital object having an additional texture, wherein the trained neural network generates the additional image based on a combination of the at least one rendered view and the refined texture; and
performing a third modification to the second modified texture data object to describe the additional texture depicted in the additional image, wherein the third modified texture data object includes third data values that are calculated based on the additional texture.

9. A system for generating a texture data object, the system comprising:
a rendering engine configured for:
rendering a first multi-view rendered image of a digital object described by a three-dimensional (“3D”) mesh, wherein the first multi-view rendered image includes a first set of multiple rendered views depicting the digital object; and
a trained neural network implementing a diffusion model, the trained neural network configured for:
generating a second multi-view diffusion-generated image of the digital object, wherein the second multi-view diffusion-generated image includes a second set of multiple diffusion-generated views depicting the digital object having an initial texture, wherein the trained neural network generates the second multi-view diffusion-generated image of the digital object based on a combination of the first multi-view rendered image and appearance input data;
the system being configured for:
performing a first modification to a texture data object to describe the initial texture depicted in the second multi-view diffusion-generated image, wherein the first modified texture data object includes first data values that are calculated based on the initial texture; and
providing the first modified texture data object to an additional computing component configured to, responsive to receiving the first modified texture data object, render the digital object having the initial texture described by the first modified texture data object.

10. The system of claim 9, the system being further configured for:
generating a mask image based on the first multi-view rendered image, wherein the mask image includes multiple mask regions; and
generating a noisy image, wherein the noisy image includes multiple noisy regions,
wherein, in the first multi-view rendered image, each particular rendered view included in the first set of multiple rendered views corresponds to i) a respective mask region of the multiple mask regions and ii) a respective noisy region of the multiple noisy regions,
wherein the trained neural network implementing the diffusion model is further configured for:
determining, for each respective noisy region of the multiple noisy regions, a respective set of cross-frame attention features, the respective set of cross-frame attention features including at least one cross-frame attention feature for one or more additional noisy region of the multiple noisy regions; and
modifying each respective noisy region based on the respective set of cross-frame attention features,
wherein, in the second multi-view diffusion-generated image, each particular diffusion-generated view included in the second set of multiple diffusion-generated views depicts a respective initial texture that is generated based on a corresponding set of cross-frame attention features for a corresponding noisy region of the multiple noisy regions.

11. The system of claim 9, wherein performing the first modification to the texture data object further comprises:
for each particular diffusion-generated view in the second set of multiple diffusion-generated views:
determining a respective texture data value describing a respective initial texture depicted by the particular diffusion-generated view; and
calculating a respective average data value that is based on a combination of i) the respective texture data value associated with the particular diffusion-generated view and ii) at least one additional respective texture data value associated with at least one additional particular diffusion-generated view in the second set of multiple diffusion-generated views,
wherein the first data values are calculated based on the respective average data value for each particular diffusion-generated view in the second set of multiple diffusion-generated views.

12. The system of claim 9, wherein:
the rendering engine is further configured for rendering a third multi-view rendered image of the digital object, wherein the third multi-view rendered image includes a third set of multiple rendered views depicting the digital object having the initial texture described by the first modified texture data object;
the trained neural network implementing the diffusion model is further configured for generating a fourth multi-view diffusion-generated image of the digital object, wherein the fourth multi-view diffusion-generated image includes a fourth set of multiple diffusion-generated views depicting the digital object having a refined texture; and
the system is further configured for performing a second modification to the first modified texture data object to describe the refined texture depicted in the fourth multi-view diffusion-generated image, wherein the second modified texture data object includes second data values that are calculated based on the refined texture.

13. The system of claim 12, wherein performing the second modification to the first modified texture data object further comprises:
for each particular triangle included in the 3D mesh:
identifying, from the fourth set of multiple diffusion-generated views, a particular diffusion-generated view having a viewing direction that is within a similarity threshold to a normal of the particular triangle; and
determining a respective texture data value describing a respective refined texture depicted by the particular diffusion-generated view,
wherein the second data values are calculated based on the respective texture data value for each particular triangle included in the 3D mesh.

14. The system of claim 12, wherein:
the rendering engine is further configured for rendering a sampling set of multiple rendered views depicting the 3D mesh for the digital object having the refined texture described by the second modified texture data object;
the system is further configured for selecting, from the sampling set, at least one rendered view that is identified as omitting the refined texture;
the trained neural network implementing the diffusion model is further configured for generating an additional image depicting an additional diffusion-generated view, the additional diffusion-generated view depicting the digital object having an additional texture, wherein the trained neural network generates the additional image based on a combination of the at least one rendered view and the refined texture; and
the system is further configured for performing a third modification to the second modified texture data object to describe the additional texture depicted in the additional image, wherein the third modified texture data object includes third data values that are calculated based on the additional texture.

15. A non-transitory computer-readable medium embodying program code for generating a texture data object, the program code comprising instructions which, when executed by a processor, cause the processor to perform:
receiving appearance input data and a three-dimensional (“3D”) mesh describing a digital object;
rendering, via a rendering engine, a first multi-view rendered image of the digital object, wherein the first multi-view rendered image includes a first set of multiple rendered views depicting the digital object and excluding the appearance input data;
generating, via a trained neural network implementing a diffusion model, a second multi-view diffusion-generated image of the digital object, wherein the second multi-view diffusion-generated image includes a second set of multiple diffusion-generated views depicting the digital object having an initial texture, wherein the trained neural network generates the second multi-view diffusion-generated image of the digital object based on a combination of the first multi-view rendered image and the appearance input data;
performing a first modification to a texture data object to describe the initial texture depicted in the second multi-view diffusion-generated image, wherein the first modified texture data object includes first data values that are calculated based on the initial texture; and
providing the first modified texture data object to an additional computing component configured to, responsive to receiving the first modified texture data object, render the digital object having the initial texture described by the first modified texture data object.

16. The non-transitory computer-readable medium of claim 15, the program code further comprising instructions which cause the processor to perform:
generating a mask image based on the first multi-view rendered image, wherein the mask image includes multiple mask regions; and
generating a noisy image, wherein the noisy image includes multiple noisy regions,
wherein, in the first multi-view rendered image, each particular rendered view included in the first set of multiple rendered views corresponds to i) a respective mask region of the multiple mask regions and ii) a respective noisy region of the multiple noisy regions,
wherein the trained neural network implementing the diffusion model is further configured for:
determining, for each respective noisy region of the multiple noisy regions, a respective set of cross-frame attention features, the respective set of cross-frame attention features including at least one cross-frame attention feature for one or more additional noisy region of the multiple noisy regions; and
modifying each respective noisy region based on the respective set of cross-frame attention features,
wherein, in the second multi-view diffusion-generated image, each particular diffusion-generated view included in the second set of multiple diffusion-generated views depicts a respective initial texture that is generated based on a corresponding set of cross-frame attention features for a corresponding noisy region of the multiple noisy regions.

17. The non-transitory computer-readable medium of claim 15, wherein performing the first modification to the texture data object further comprises:
for each particular diffusion-generated view in the second set of multiple diffusion-generated views:
determining a respective texture data value describing a respective initial texture depicted by the particular diffusion-generated view; and
calculating a respective average data value that is based on a combination of i) the respective texture data value associated with the particular diffusion-generated view and ii) at least one additional respective texture data value associated with at least one additional particular diffusion-generated view in the second set of multiple diffusion-generated views,
wherein the first data values are calculated based on the respective average data value for each particular diffusion-generated view in the second set of multiple diffusion-generated views.

18. The non-transitory computer-readable medium of claim 15, the program code further comprising instructions which cause the processor to perform:
rendering, via the rendering engine, a third multi-view rendered image of the digital object, wherein the third multi-view rendered image includes a third set of multiple rendered views depicting the digital object having the initial texture described by the first modified texture data object;
generating, via the trained neural network implementing the diffusion model, a fourth multi-view diffusion-generated image of the digital object, wherein the fourth multi-view diffusion-generated image includes a fourth set of multiple diffusion-generated views depicting the digital object having a refined texture; and
performing a second modification to the first modified texture data object to describe the refined texture depicted in the fourth multi-view diffusion-generated image, wherein the second modified texture data object includes second data values that are calculated based on the refined texture.

19. The non-transitory computer-readable medium of claim 18, wherein performing the second modification to the first modified texture data object further comprises:
for each particular triangle included in the 3D mesh:
identifying, from the fourth set of multiple diffusion-generated views, a particular diffusion-generated view having a viewing direction that is within a similarity threshold to a normal of the particular triangle; and
determining a respective texture data value describing a respective refined texture depicted by the particular diffusion-generated view,
wherein the second data values are calculated based on the respective texture data value for each particular triangle included in the 3D mesh.

20. The non-transitory computer-readable medium of claim 18, the program code further comprising instructions which cause the processor to perform:
rendering, via the rendering engine, a sampling set of multiple rendered views depicting the 3D mesh for the digital object having the refined texture described by the second modified texture data object;
selecting, from the sampling set, at least one rendered view that is identified as omitting the refined texture;
generating, via the trained neural network implementing the diffusion model, an additional image depicting an additional diffusion-generated view, the additional diffusion-generated view depicting the digital object having an additional texture, wherein the trained neural network generates the additional image based on a combination of the at least one rendered view and the refined texture; and
performing a third modification to the second modified texture data object to describe the additional texture depicted in the additional image, wherein the third modified texture data object includes third data values that are calculated based on the additional texture.
